(19) United States
(12) Patent Application Publication
(10) Pub. No.: US 2018/0000004 A1
(43) Pub. Date: Jan. 4, 2018

(54) CONTINUOUS ULTRASONIC TREATMENT OF SEEDS

(71) Applicant: BKR IP Holdco LLC, Broomall, PA (US)

(72) Inventor: Bruce K. REDDING, Jr., Broomall, PA (US)

(21) Appl. No.: 15/545,518

(22) PCT Filed: Feb. 2, 2016
(86) PCT No.: PCT/US16/16232

§ 371 Date: Jul. 21, 2017

Related U.S. Application Data
(60) Provisional application No. 62/125,836, filed on Feb. 2, 2015.

(51) Int. Cl. A01C 1/02; C02F 1/36; B01J 19/10

(52) U.S. Cl. CPC A01C 1/02; B01J 19/10; C02F 1/36

(57) ABSTRACT

A process and an apparatus continuously treat seeds with ultrasonic transmission. The process includes mixing seeds with a flowable medium to create a flowable slurry of seeds; continuously moving the flowable slurry of seeds for a length of a flow pipe through a helical path within the flow pipe; and as the flowable slurry flows through the helical path within the for the length of the flow pipe, subjecting the seeds to ultrasonic transmission created by ultrasonic transducers arranged along the length of the flow pipe. The seeds in the flowable slurry are subjected to the ultrasonic transmission having such waveforms and being transmitted in a manner so as not to damage the seeds and to produce ultrasonically-treated seeds that have regulated germination characteristics, such that plants resulting from the ultrasonically-treated seeds when the seeds are planted have affected growth characteristics. The apparatus effects this process.

### CROSS-REFERENCE TO RELATED APPLICATIONS

This application is a 371 National Filing of International Patent application Patent Application No. PCT/US2016/016232, filed Feb. 2, 2016, which claims priority to U.S. Provisional Application No. 62/125,836, filed Feb. 2, 2015, the contents of which are hereby incorporated herein by reference in their entireties.

### BACKGROUND OF THE INVENTION

### Field of the Invention

The invention relates generally to a sonication and imbibition process for the uptake of water or other substances along with dissolved substances into a seed, more specifically, to a method of treating seeds with sound waves for the purpose of imparting to the seed a memory for enhanced uptake of a substance that enhances a growth characteristic of the seed or resultant plant, or otherwise adds value to the seed during commercial processing. In particular, this invention incorporates the discovery that seeds, once planted in the soil and subjected to ultrasonic energy tend to mature at a faster pace than conventionally planted seeds. Several embodiments are disclosed, including a laboratory device, a pilot batch processing system and a design for a continuous processing system which applies ultrasound to seeds traveling the length of a processor, which can be through a sonicated pipe and can include a helical system.

### Background of the Prior Art

Seed dormancy is a unique form of developmental arrest utilized by most plants to temporally disperse germination and optimize progeny survival. During seed dormancy, moisture content and respiration rate are dramatically lowered. The initial step to break seed dormancy is the uptake (imbibition) of water necessary for respiration and mobilization of starch reserves required for germination. Imbibition is a biphasic process: I) the physical uptake of water through the seed coat and hydration of the embryo; and II) germination as determined by growth and elongation of the embryonic axis resulting in emergence of the plumule and radicle. The two phases are separated temporally, and seed that have completed phase I is said to be “primed seed,” that is, primed for phase II: germination. Phase I of imbibition is also used in the commercial processing of seed, i.e. wet milling fractionation of corn and the malting process for the fermentation of distilled spirits.

Priming of seed by the enhanced imbibing of water is advantageous to plant vigor, e.g. enhanced emergence, growth and yield characteristics. Seed priming also synchronizes the germination of seed resulting in a uniform field of plants that mature simultaneously for maximal yields at harvest. In addition to water, seed priming provides access to load the seed with nutrients, microorganisms, or pest inhibitors to promote seedling establishment. By adding a molecule to the seed during imbibition phase I, the molecule or organism can be stored in the primed seed and therefore, be present at planting. The “loading of macromolecules” is very efficient in the seed when compared to the addition of similar molecules to the entire field. An example is the addition of fertilizer to stimulate root growth and hasten seedling emergence. The loading of the fertilizer into the seed prior to planting is more efficacious to the seedling and cost effective to the farmer. Other beneficial molecules to be loaded into seed are hormones such as the gibberelins/gibberellic acid to promote germination, cytokinins for cell elongation and inhibitors of abscisic acid to promote release from seed dormancy. Seed cultivars could be customized to specific growing regions by the addition of triazoles (plant growth regulators which moderate the effects of drought and high temperatures) or fungicides to inhibit the growth of fungi on seed and seedlings in cool, wet soil or insecticides to combat insects that attack seedlings such as corn rootworm. In addition to macromolecules, beneficial microorganisms such as Azospirillum or Rhizobium can be loaded during seed priming as a crop inoculant.

The commercial fractionation of corn begins with wet milling. Corn is a complex mixture of starch, protein, oil, water, fiber, minerals, vitamins, and pigments. Wet milling is the process of separating the corn components into separate homogenous fractions. In Iowa, approximately 20% of the 1 billion bushels of corn harvested each year is wet milled. The wet milling industry and collateral manufacturing represent a prodigious industrial effort. As the wet milling process is constantly refined by new technologies, novel by-products can be isolated in industrial quantities, e.g. ethanol, corn sweeteners, protein peptides, and vitamins C and E. The initial step in wet-milling, steeping, has not been altered by technological innovation. Steeping involves soaking the clean and dried corn (<16% water content) in warm water until it has swollen to 45% hydration. This process takes from 30-50 hr. at temperatures of 120-130° F. During the steeping process, large quantities of water are moved through massive vats of corn in a countercurrent stream. Also, during this time, beneficial microorganisms such as the lactobacteria and Pseudomonas aeruginosa growing in the steep water aid in the proteolytic cleavage of corn proteins. However, the large volumes of steep water and the time required for hydration limit the effectiveness of the bacterial digestion. The digestion by-products are purified from the steep water primarily by evaporative concentration.

The malting process is the first step in the fermentation of grain to produce alcoholic spirits. The quality of the malt (and the resulting fermentation) is dependent upon the synchronous and efficient germination of the grain. Starches stored in the seed are converted into sugars during early stages of germination. At emergence, germination is halted and converted sugars are used during fermentation for the production of ethanol. Historically, the malting process was a labor-intensive task. The grain was spread onto a “malting floor, imbibed with water from overhead sprinklers, and turned by hand daily over the course of one to two weeks to release trapped heat and gases. At plumule emergence, the starches have been converted to sugars, the germinated grain is kiln dried and ground to form malt. Microbreweries and distilleries still use variations of this old malting technique to produce high quality malt. Some distilleries induce uniform germination by the addition of gibberllic acid (GA) to produce the highest quality of malt for fermentation such as in single malt scotch distillation. GA is the plant hormone, which regulates germination. Malt production of this quality is time consuming and expensive.

### Normal Plant Germination

Water is the key factor that aids the germination of a seed. A seed can be prepared for germination by moistening. Care is to be taken not to over soak the seed fully in water. When water penetrates the seed, the seed bulges as shown in FIG. 1. When the seed coat softens, the seed breaks and the seedling emerge out. Seeds usually have some amount of stored food inside. When treated with water, this food is supplied to the seedling, aiding germination. FIG. 2 illustrates the growth of a plant from germination to full development.

You will see a wide variety of trees in your surroundings. Trees play an important role in maintaining the ecosystem and keeping the environment refreshing and pollution-free. Whenever you watch small or big trees, plants or shrubs, you must be curious about their growth and life cycle. Life cycle of any plant is divided in different phases and seed germination is basic stage to start the growth of plant. You may think that a seed is lifeless, but it is not true. It consists of plant in a resting, embryonic condition. Whenever it gets favorable environmental conditions, it starts to germinate. This process occurs through different steps in seed germination. An inactive seed lying in the ground needs warmth, oxygen, and water to develop into a plant.

### Seed Structure

The seed coat is the outer covering of a seed, which protects the embryo from any kind of injury, entry of parasites and prevents it from drying. The seed coat may be thick and hard, or thin and soft. Endosperm is a temporary food supply, which is packed around the embryo in the form of cotyledons or seed leaves. Plants are classified as monocots and dicots depending upon number of cotyledons.

### Requirements for Seed Germination

All seeds need adequate quantity of oxygen, water and temperature for germination. Some seeds also need proper light. Some can germinate well in presence of full light, while others may require darkness to start germination. Water is required for vigorous metabolism. Soil temperature is equally important for appropriate germination. Optimum soil temperature for each seed varies species to species.

### Factors

There are several factors that can affect germination process. Over watering can prevent the plant from getting enough oxygen. If the seed is deeply planted in soil, then it can use all the stored energy before reaching soil surface. Dry conditions can prevent germination, as seed doesn't get enough moisture. Some seeds have a seed coat so hard that oxygen and water cannot get through it. If the soil temperature is extremely low or high, then it can affect or prevent the germination process.

### Steps Involved

1. The seed absorbs water and the seed coat bursts. It is the first sign of germination. There is an activation of enzymes, increase in respiration and plant cells get duplicated. A chain of chemical changes starts which leads to development of a plant embryo.

2. Chemical energy stored in the form of starch is converted to sugar, which is used during the germination process. Soon, the embryo gets enlarged and the seed coat bursts open.

3. A growing plant emerges. The tip of a root first emerges and helps to anchor the seed in place. It also allows the embryo to absorb minerals and water from the soil.

4. Some seeds require special treatments of temperature, light or moisture to start germination.

5. The steps in seed germination can be different in dicots and monocots.

### Germination in Dicots

During the germination process of dicots, such as tomatoes, peas, peppers, roses, geraniums, among a great many others, the primary root emerges through the seed coat when the seed is buried in soil. A hypocotyl emerges from the seed coat through the soil. As it grows up, it takes the shape of a hairpin, known as the hypocotyl arch. Epicotyl structures, plumule, are protected by two cotyledons from any kind of mechanical damage. When the hypocotyl arch emerges out from the soil, it becomes straight, which is triggered by light. Cotyledons spread apart exposing the epicotyl, which contains two primary leaves and an apical meristem. In many dicots, cotyledons supply food stores to the developing plant and also turn green to produce more food by the process of photosynthesis.

### Germination in Monocots

During germination of monocots, for example grass seeds such as wheat, oats or corn, among many others, the primary root emerges from the seed and fruit and grows down. Then, the primary plant's primary leaf grows up. It is protected by a cylindrical, hollow structure known as the coleoptile. Once the seedling grows above the soil surface, growth of the coleoptile is stopped and it is pierced by a primary leaf.

Of course, all the seeds lying in the ground are not lucky enough to get a proper environment to germinate. Many seeds tend to get dried and cannot develop into a plant. Some seeds get a sufficient amount of water, oxygen, and warmth, and seed germination starts.

### Climate Change and Reduction of Plant Growth Times

As climate change globally can affect the time available for crop growth, generally making conditions for growth more severe and the growing periods shorter, the need to reduce and enhance seed growth and eventual plant production and harvesting within a shorter time period become apparent.

Thus, a need exists for (1) a method to enhance the ability of seeds to imbibe water and other substances and to (2) reduce the time needed for plant growth.

### BRIEF SUMMARY OF THE INVENTION

One aspect of the invention is a process for continuously treating seeds with ultrasonic transmission, the process comprising:

mixing seeds with a flowable medium to create a flowable slurry of seeds;

continuously moving the flowable slurry of seeds for a length of a flow pipe through a helical path within the flow pipe; and

as the flowable slurry flows through the helical path within and for the length of the flow pipe, subjecting the seeds to ultrasonic transmission created by ultrasonic transducers arranged along the length of the flow pipe;

the seeds in the flowable slurry being subjected to the ultrasonic transmission having such waveforms and being transmitted in a manner so as not to damage the seeds and to produce ultrasonically-treated seeds that have regulated germination characteristics, such that plants resulting from the ultrasonically-treated seeds when the seeds are planted have affected growth characteristics.

Another aspect of the invention is an apparatus for treating seeds continuously with ultrasonic transmission, the seeds being mixed with a flowable first medium that creates a flowable slurry of seeds, the flowable slurry continuously moving for a length of a flow pipe through a helical path within the flow pipe, the apparatus comprising:

a flow pipe having an internal structure that forms a helical path for the length of the flow pipe for the flowable slurry that flows from an inlet to an outlet of the flow pipe; and

a plurality of ultrasonic transducers with a power supply for generating the ultrasonic transmission by the transducers, the transducers arranged along the length of the flow pipe and of sufficient number and placement to provide ultrasonic transmission to the flowable slurry of seeds as they travel through the helical path;

the ultrasonic transmission being applied by the ultrasonic transducers in a manner so as not to damage the seeds and to produce ultrasonically-treated seeds that have regulated germination characteristics, such that plants resulting from the ultrasonically-treated seeds when the seeds are planted have affected growth characteristics.

Both cavitation ultrasound or ultrasonic transmission and the use of alternating waveform ultrasound or ultrasonic transmission can be employed to treat various seeds to increase the speed of germination of the seed, and therefore reduce the time for plant growth maturity.

### Cavitational Ultrasound

Sinusoidal ultrasonic energy generates cavitational forces by the adiabatic collapse of micro bubbles in the liquid medium, particularly those bubbles that collapse at the surface of the seed. The ultrasonic cavitational forces impart an enhanced stable memory for the seeds to imbibe water and/or other substances beneficial to the seed and/or plant. The ultrasonically treated seed can be dried, stored, and later imbibed with a substance that enhances a growth characteristic of the seed or resultant plant. Upon germination, the plant maintains the enhanced growth characteristics.

### Alternating Ultrasonic Transmission

Alternating the ultrasonic transmission where the first part of the transmission is a first waveform and a second, alternating part is another type or shape of waveform can be employed. An advantage of alternating ultrasonic transmission is that cavitation is reduced or preferably avoided, so as not to damage seeds, while allowing the seeds to be treated so that they have enhanced germination characteristics. The alternating ultrasonic transmission applies the ultrasonic energy and the effect of faster seed germination more effectively than the use of sinusoidal cavitational ultrasonic energy generates seed germination.

Copending U.S. patent application Ser. No. 13/986,757, filed Jun. 3, 2013, by the same inventor as the present applicant and inventor, Bruce K. Redding, Jr., and published Dec. 4, 2014, under application publication No. US 2014/0352210 A1, the disclosure of which is hereby incorporated herein by reference in its entirety, describes treating seeds in a liquid medium with ultrasound for the purpose of speeding germination and eventual plant maturity. The present invention is an improvement over the invention disclosed in that prior application and allows for efficient commercial exploitation of the ultrasonic treatment of seeds on a using a process and an apparatus for continuously treating seeds by applying the ultrasonic transmission as a slurry of seeds travel through a helical path within and through the length of a flow pipe, where transducers along the length of the flow pipe apply ultrasonic transmission to the slurry, and therefore, to the seeds in the slurry.

A purpose of this invention is to impart upon seeds through a sonication and imbibition process a reduction of the time needed for germination of the seed, and therefore to speeding the maturing of the plant resulting from the ultrasonically-treated seed.

One object of this invention is the continuous sonification of seeds to increase the speed of sonification and the volume of seeds which can be so treated, as well as providing for a more cost effective sonification methodology than a batch treatment of seeds.

This purpose and object, as well as other purposes, objects, advantages and benefits of the invention will be made clear to a person of ordinary skill in the art upon a reading and understanding of this specification, the associated drawings, and appended claims.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

FIG. 1 is a photograph of a germinated seed.

FIG. 2A is a depiction of the process of seed germination in a dicot, such as tomatoes, peas, peppers, roses and geraniums, among a great many others, to a developed plant.

FIG. 2B is a depiction of the process of seed germination in a monocot, such as wheat, oats, and corn, among a great many others, to a developed plant

FIG. 3 is a scanning electron microphotograph of a collection of untreated, or raw, wheat seeds, which are small, all passing through a size 60 mesh screen (with openings of 0.0098 inch or 250 microns).

FIG. 4 is a scanning electron microphotograph of a collection of wheat seeds, treated ultrasonically, where ordinary sinusoidal ultrasound was applied to the seed for 5 minutes, showing that resultant cavitation has partially melted the seed.

FIG. 5 illustrates the effects of conventional ultrasound or ultrasonic transmission, in the development of intense heating effects caused by cavitation, which could damage the seed as shown in FIG. 4, where hot spots develop above 400 milliseconds with damage to seeds likely.

FIG. 6 schematically illustrates an effect of cavitation with the development of micro-bubbles, which upon collapse, generate intense thermal effects, and unless controlled, can damage seeds.

FIG. 7 illustrates a preferred embodiment of ultrasonic waveforms used in this invention, wherein alternating waveforms, such as the preferred sawtooth waveform that alternates with the preferred square waveform, which minimizes or is without any cavitation effect on the skin, sheath or shell of a seed that avoids damage to the skin, sheath or shell, but still speeds uptake or moisture, be it plain water or water with other adjuvants to affect germination of the seed in a desirable manner. Typically, such alternating waveforms of ultrasonic transmission are employed to reduce the time needed for germination of seeds and speedier development of resultant plants or crops.

FIG. 8 is a scanning electron microphotograph of a collection of ultrasonically treated, wheat seeds, showing the effect on one such seed, processed according to Experiment 1.

FIG. 9 is an illustration of a laboratory system for batch treating seeds with ultrasound.

FIG. 10 is an illustration of a schematic batch treatment system for treating seeds with ultrasound.

FIG. 11 is an illustration of an ultrasonic treatment of seeds using an ultrasonic flow cell system.

FIG. 12 is a schematic illustration of apparatus for the ultrasonic treatment of seeds via an ultrasonic flow pipe system.

FIG. 13 is a schematic illustration of one embodiment of a continuous ultrasonic seed processor using an ultrasonic flow pipe cell system for treating seeds with ultrasound, followed by a filtration system leading to a drier for removing moisture from ultrasonically treated seeds.

FIG. 14 is a schematic illustration of another embodiment of an apparatus for the ultrasonic treatment of seeds on a continuous basis, involving a spiral or helical path within a flow pipe, and with a recycle provision, followed by a filtration system leading to a drier for removing moisture from ultrasonically treated seeds.

FIG. 15 is a schematic illustration of an embodiment of a continuous ultrasonic system for treating seeds with ultrasound, involving a spiral or helical flow pipe design, further showing an embodiment of placement of ultrasonic transducers affixed directly to the spiral or helical tubing.

FIG. 16 is an illustration of an embodiment of a helical path flow tubing which rotates seeds as they are traveling through the helical or spiral unit in a continuous ultrasonic system for treating seeds with ultrasound.

FIG. 17 is an illustration of an embodiment of a flow pipe in the form of a cover or jacket having a square cross-section except for its ends, which fits over and around the internal spiral or helical flow pipe design illustrated in FIG. 16. This drawing illustrates the jacket which can be loaded with a liquid medium, typically comprising water, which may be either cold or warm water, and which will allow the ultrasonic transmission from transducers placed on the exterior, or alternatively within the jacket to treat a flowable slurry of seeds within the helical tubing travels in a helical path as along the length spiral tubing within the flow pipe.

FIG. 18 is an illustration of the embodiments of an apparatus for the ultrasonic treatment of seeds in a continuous processing system, which includes a flow pipe cover or jacket of FIG. 17 over and around the internal spiral or helical flow pipe design illustrated in FIG. 16. There are end caps that screw into both ends of the flow pipe cover or jacket that support the ends of the internal spiral or helical tubing within the flow pipe.

FIG. 19 is an illustration of details of the end caps shown in FIG. 18, which fit into the ends of the flow pipe cover or jacket and support the ends of the internal spiral or helical tubing device for the continuous treatment of seeds ultrasonically.

FIG. 20 is a photograph of a continuous ultrasonic system for treating seeds that illustrates a conveyor in the form of a pump for the flowable slurry of seeds and the placement of ultrasonic transducers on the exterior of the flow pipe cover or jacket with the square cross-section shown in FIG. 18 and along its length where the spiral or helical path for the flowable slurry of seeds is inside the flow pipe.

FIG. 21 is a photograph showing another view of the flow pipe having a square cross-section as shown in FIG. 18, held within a stabilizing base, and assembled with the end caps of FIGS. 18 and 19 and with the internal helical path as shown in FIGS. 16 and 18 for the flowable slurry of seeds within the flow pipe. This assembly shows the continuous processor system used in the experiments set forth below.

FIG. 22 is a photograph showing another view of the flow pipe having a square cross-section as shown in FIG. 18, held within a stabilizing base, with ultrasonic transducers externally affixed to sides and along the length of the flow pipe, and assembled with the end caps of FIGS. 18 and 19 and with the internal helical path as shown in FIGS. 16 and 18 for the flowable slurry of seeds within the flow pipe. This assembly shows the continuous processor system including the flow pump for the flowable slurry of seeds and tubing connected to the helical flow tubing at the outlet end and tubing connected to a source of seeds in the form of a seed tank containing the a flowable slurry of seeds as used in the experiments set forth below.

FIG. 23A is a photograph showing an enlarged view of the flow pipe of FIG. 22.

FIG. 23B is a photograph showing an enlarged view of the flow pipe of FIG. 21 and the internal helical flow tube for the flowable slurry of seeds, as well as a sealable port for a liquid medium to be within the flow pipe cover or jacket and around the internal helical flow tube for the flowable slurry of seeds.

FIG. 23C is a photograph showing a further enlarged view of a portion of the flow pipe of FIGS. 21 and 23B with the internal helical flow tube for the flowable slurry of seeds.

FIG. 23D is a photograph showing a still more enlarged view of a portion of the flow pipe of FIGS. 21, 23B and 23C with an end cap supporting the internal helical flow tube for the flowable slurry of seeds.

FIG. 23E is a photograph showing a yet further enlarged view of a portion of the flow pipe of FIGS. 21, 23B, 23C and 23D with a portion of an end cap and the internal helical flow tube for the flowable slurry of seeds.

FIG. 24 is an illustration and two photographs of an embodiment of a unique ultrasonic transducer assembly and design capable of producing or generating an alternating ultrasonic waveform transmission.

FIG. 25 is a photograph of an ultrasonic transducer coupler including an array having multiple transducer elements adhesively affixed to a face plate for the transducer assembly of FIG. 24.

FIG. 26 is a photograph of another embodiment of an ultrasonic transducer assembly in the process of being assembled to its block and reflective cover with wires running through the cover and including a foam ring adhesively adhering the transducer face plate to the rim of the block and reflective cover subassembly.

FIG. 27 includes two photographs showing the final assembly step and the finished assembly of the ultrasonic transducer shown in FIG. 26.

FIG. 28 is a photograph of the system or rigging for generating and controlling ultrasonic transmission in a preferred embodiment of the process and apparatus of the invention.

### DETAILED DESCRIPTION OF THE INVENTION

As used herein, the singular forms “a,” “an,” and “the” include plural referents, and plural forms include the singular referent unless the context clearly dictates otherwise.

As used herein, the term “about,” “approximate” or “approximately” with respect to any numerical value or location parameter, means that the numerical value has some reasonable leeway and is not critical to the function or operation of the component being described or the system or subsystem with which the component is used.

The present invention includes various aspects, as follows.

Aspect 1. A process for continuously treating seeds with ultrasonic transmission, the process comprising:

mixing seeds with a flowable medium to create a flowable slurry of seeds;

continuously moving the flowable slurry of seeds for a length of a flow pipe through a helical path within the flow pipe; and

as the flowable slurry flows through the helical path within and for the length of the flow pipe, subjecting the seeds to ultrasonic transmission created by ultrasonic transducers arranged along the length of the flow pipe;

the seeds in the flowable slurry being subjected to the ultrasonic transmission having such waveforms and being transmitted in a manner so as not to damage the seeds and to produce ultrasonically-treated seeds that have regulated germination characteristics, such that plants resulting from the ultrasonically-treated seeds when the seeds are planted have affected growth characteristics.

Aspect 2. The process of aspect 1, wherein the regulated germination characteristics are enhanced germination characteristics.

Aspect 3. The process of aspect 2, wherein the enhanced germination characteristics are caused by the seeds being imparted with at least one germination-enhancing substance from the slurry as the seeds are subjected to the ultrasonic transmission while the flowable slurry travels in the helical path through the length of the flow pipe.

Aspect 4. The process of aspect 3, wherein the germination-enhancing substance is selected from the group consisting of water, a fertilizer, a nutrient, a beneficial microorganism, a pest inhibitor, a hormone that promotes germination, a cytokinin that aids in cell elongation, an inhibitor of abscisic acid that promotes release from a dormancy condition of the seeds, and any combination thereof.

Aspect 5. The process of aspect 1, wherein the affected growth characteristics are any one or more of resistance to damage caused by a lack of sufficient water or excess water, regulated germination during cold temperatures, regulated germination during hot temperatures, and any combination thereof.

Aspect 6. The process of aspect 5, wherein the affected growth characteristics are regulated by uptake into the ultrasonically-treated seeds as the flowable slurry travels in the helical path along the length of the flow pipe of a substance in the flowable slurry selected from the group consisting of a triazole that moderates the effects of the lack of sufficient water and high temperatures; a fungicide that inhibits growth of fungi on the ultrasonically-treated seeds or seedlings resulting from the ultrasonically-treated seeds in cool, wet soil; and a growth retardant to retard germination of the seeds or any plants resulting from the seeds.

Aspect 7. The process of aspect 1, wherein the flowable medium comprises air.

Aspect 8. The process of aspect 1, wherein the flowable medium comprises water.

Aspect 9. The process of aspect 1, wherein the seeds are present in the flowable medium at a concentration of about 1% by weight to about 30% by weight.

Aspect 10. The process of aspect 1, wherein the flowable medium comprises water and the seeds are present in the flowable medium at a concentration of about 30% by weight.

Aspect 11. The process of aspect 1, wherein the flowable slurry flows through the length of the flow pipe at a rate of about 0.2 inch (0.51 cm) per second to about 1 inch (2.54 cm) per second.

Aspect 12. The process of aspect 1, wherein the ultrasonic transmission is at a frequency of about 15 kHz and about 175 kHz.

Aspect 13. The process of aspect 12, wherein the ultrasonic transmission is at a frequency of about 23 kHz and about 30 kHz.

Aspect 14. The process of aspect 1, wherein the ultrasonic transmission is at an energy density of about 0.125 watt/cm² to about 10 watts/cm².

Aspect 15. The process of aspect 1, wherein the ultrasonic transmission is at an energy density of about 0.5 watt/cm².

Aspect 16. The process of aspect 1, wherein the ultrasonic transmission is applied continuously.

Aspect 17. The process of aspect 1, wherein the ultrasonic transmission is applied in a pulsed manner.

Aspect 18. The process of aspect 1, wherein the ultrasonic transmission has one or more waveforms selected from the group consisting of sinusoidal, triangular, sawtooth and square.

Aspect 19. The process of aspect 1, wherein the ultrasonic transmission creates cavitation in the slurry, but does not damage the seeds.

Aspect 20. The process of aspect 1, wherein the ultrasonic transmission has one or more waveforms selected from the group consisting of sinusoidal, triangular, sawtooth and square and does not create cavitation in the slurry.

Aspect 21. The process of aspect 20, wherein the ultrasonic transmission has one or more alternating waveforms selected from the group consisting of sinusoidal, triangular, sawtooth and square and does not create cavitation in the slurry.

Aspect 22. The process of aspect 21, wherein the ultrasonic transmission has a sawtooth waveform alternating with a square waveform and does not create cavitation in the slurry.

Aspect 23. The process of aspect 22, wherein the sawtooth waveform and the square waveform alternate at intervals, and wherein each interval for each waveform is about 10 milliseconds to less than 400 milliseconds.

Aspect 24. The process of aspect 23, wherein the sawtooth waveform and the square waveform alternate at intervals of about 50 milliseconds each.

Aspect 25. The process of aspect 1, wherein the seeds are present in the flowable medium at a concentration of about 1% by weight to about 30% by weight, the flowable slurry flows through the length of the flow pipe at a rate of about 0.2 inch (0.51 cm) per second to about 1 inch (2.54 cm) per second, and the ultrasonic transmission is at a frequency of about 10 KHz to about 175 KHz and at an energy density of about 0.125 watt/cm² to about 10 watts/cm².

Aspect 26. The process of aspect 25, wherein the flowable medium comprises water, the seeds are present in the flowable medium at a concentration of about 5% by weight to about 30% by weight, the flowable slurry flows through the length of the flow pipe at a rate of about 0.3 inch (0.76 cm) per second to about 1 inch (2.54 cm) per second, and the ultrasonic transmission is at a frequency of about 15 KHz to about 100 KHz and at an energy density of about 0.225 watt/cm² to about 10 watts/cm².

Aspect 27. The process of aspect 26, wherein the flowable medium comprises water, the seeds are present in the flowable medium at a concentration of about 30% by weight, the flowable slurry flows through the length of the flow pipe at a rate of about 0.33 inch (0.84 cm) per second, and the ultrasonic transmission is at a frequency of about 20 KHz to about 23 KHz and at an energy density of about 0.5 watt/cm², with the ultrasonic transmission being in the form of alternating sawtooth waveforms and square waveforms, the sawtooth waveform and the square waveform alternating at intervals of about 50 milliseconds each.

Aspect 28. The process of aspect 27, wherein the flowable medium is a liquid medium, the process further comprising at least one of filtering and drying the treated seeds.

Aspect 29. The process of aspect 1, wherein the flowable medium is a liquid medium, the process further comprising drying the treated seeds.

Aspect 30. Apparatus for treating seeds continuously with ultrasonic transmission, the seeds being mixed with a flowable first medium that creates a flowable slurry of seeds, the flowable slurry continuously moving for a length of a flow pipe through a helical path within the flow pipe, the apparatus comprising:

a flow pipe having an internal structure that forms a helical path for the length of the flow pipe for the flowable slurry that flows from an inlet to an outlet of the flow pipe; and

a plurality of ultrasonic transducers with a power supply for generating the ultrasonic transmission by the transducers, the transducers arranged along the length of the flow pipe and of sufficient number and placement to provide ultrasonic transmission to the flowable slurry of seeds as they travel through the helical path;

the ultrasonic transmission being applied by the ultrasonic transducers in a manner so as not to damage the seeds and to produce ultrasonically-treated seeds that have regulated germination characteristics, such that plants resulting from the ultrasonically-treated seeds when the seeds are planted have affected growth characteristics.

Aspect 31. The apparatus of aspect 30, wherein the helical path is created by internal baffles in the flow pipe arranged to direct the flowable slurry in the helical path.

Aspect 32. The apparatus of aspect 30, wherein the helical path is created by a helical tube within the flow pipe through which the flowable slurry flows through the helical tube for the length of the flow pipe.

Aspect 33. The apparatus of aspect 30, further comprising a pump to pump the flowable slurry through helical tube.

Aspect 34. The apparatus of aspect 30, wherein the helical path is created by a helical tube within the flow pipe through which the slurry flows through the helical tube for the length of the flow pipe;

the apparatus further comprising:

a pump to pump the flowable slurry through helical tube; and

the flow pipe is sealable to contain a liquid second medium within the flow pipe and surrounding the helical tube, such that the ultrasonic transmission is transmitted to the seeds in the helical tube through the liquid second medium.

Aspect 35. The apparatus of aspect 34, wherein the ultrasonic transducers are placed on the exterior of the flow tube, the flow tube having walls though which the ultrasonic transmission is capable of being transmitted.

Aspect 36. The apparatus of aspect 30, wherein the ultrasonic transducers are placed on the exterior of the flow tube, the flow tube having walls though which the ultrasonic transmission is capable of being transmitted.

Aspect 37. The apparatus of aspect 30, wherein the flowable first medium that creates the slurry for the flowable slurry of seeds is a liquid medium; and

wherein the apparatus further comprises:

a dryer to dry the ultrasonically-treated seeds; and

a conveyor to convey the ultrasonically-treated seeds to the dryer.

Aspect 38. The apparatus of aspect 37, wherein the conveyor is a pump capable of pumping to the dryer the flowable slurry of ultrasonically-treated seeds.

Aspect 39. The apparatus of aspect 38, wherein the conveyor is a moveable conveyor belt upon which the ultrasonically-treated seeds are deposited and conveyed to the dryer.

Aspect 40. The apparatus of aspect 37, wherein the flowable first medium that creates the slurry for the flowable slurry of seeds is a liquid medium; and

wherein the apparatus further comprises a filter to filter the ultrasonically-treated seeds from the liquid first medium containing the seeds that creates the flowable slurry.

Aspect 41. The apparatus of aspect 30, wherein each ultrasonic transducer is capable of generating from electrical input signals matching output alternating ultrasonic waveforms as the ultrasonic transmission, the transducer comprising:

one or more piezoelectric or magnetorestrictive discs, each disc being affixed onto a stainless steel face plate by an electrically conductive adhesive, the face plate being electrically connected to an ultrasonic generator that generates the electrical input signals and the matching output alternating ultrasonic waveforms as the ultrasonic transmission;

a plastic or metal block enclosure with a reflective cover containing the discs and overlying the stainless steel face plate; and

a foam rubber ring which connects the stainless steel face plate to the enclosure to enable the face plate to vibrate harmonically with respect to the ultrasonic transmissions from the transducer discs;

the reflective cover containing the discs and overlying the face plate reflecting the ultrasonic transmissions from the face plate back toward the face plate to concentrate the intensity and direction of the ultrasonic transmission.

A description and explanation of the invention, including the foregoing aspects, follows.

The invention includes a novel sonication process to treat seeds with ultrasonic energy, referred to herein as “ultrasonic transmission.” The process imparts an enhanced stable memory in a seed, including dried and stored seeds, for subsequent uptake of a substance into a seed, particularly a substance useful for enhancing a growth characteristic of the seed with that characteristic transferring to an advantage for the resultant plant, and for the uptake of water into seeds for processing purposes. The growth characteristic is enhanced through the use of ultrasound, transmitted either using a sinusoidal ultrasonic transmission which may cause appropriate and controlled cavitation, or one which employs alternating ultrasonic transmissions which rotate from one ultrasonic waveform to another, such as among sinusoidal, sawtooth, triangular, and square, and preferably, sawtooth alternating with square waveforms. The alternating waveforms, particularly those which do not include the sinusoidal waveform typically generated and transmitted using ultrasonic generators, result in minimized or preferably no cavitation, which if not controlled carefully, can damage seeds so that they are less or not viable.

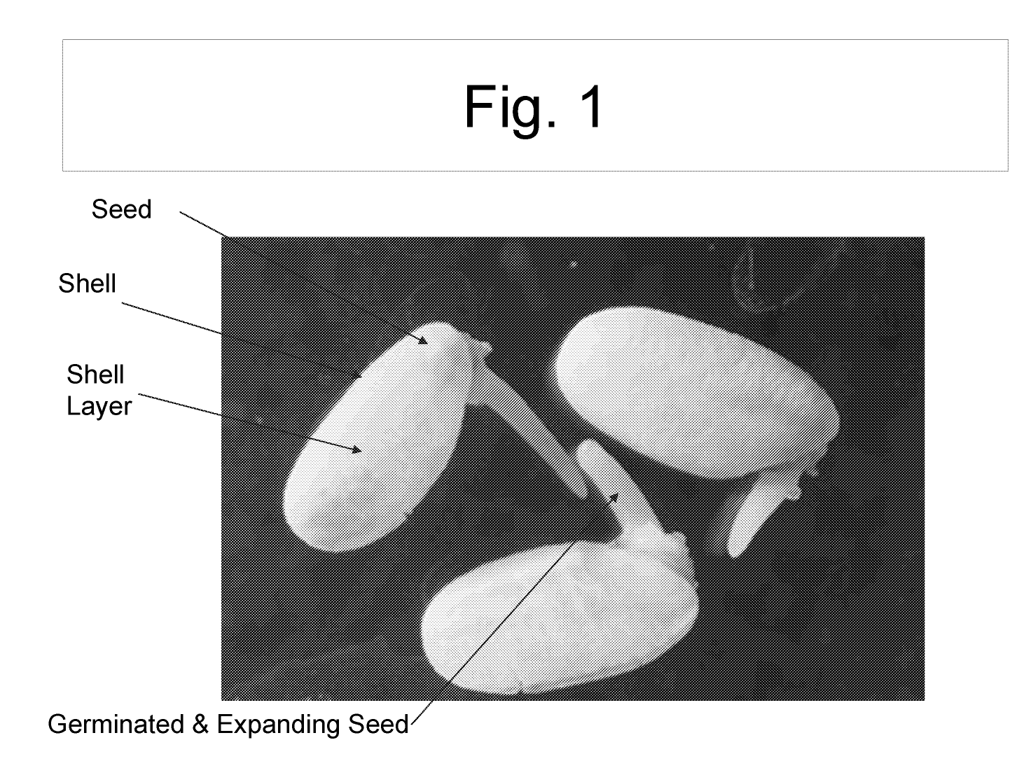

In the way of further illustrative examples of applications of the present invention, it is anticipated that the present process or method is applicable to soften the outer shell layer of a seed's shell as seen in FIG. 1 using an ultrasound based treatment system, to better allow the cracking of the seed shell itself, and removing or penetrating the outer shell layer of the seed. This has the effect of speeding the germination of the seed, i.e. the ability of the seed to germ. As demonstrated herein, the sonication and imbibition process of the present invention dramatically reduces the time required for steeping by accelerating the uptake of the water solution into the seed itself. The text information on FIG. 1 is hereby incorporated into this description.

The biochemistry of this process begins with the imbibition of water through the seed coat and into the interior of the seed. Using corn seeds as an example: The water reacts with the cell embryo in a manner that releases a chemical known as gibberellic acid (GA), a plant hormone. The GA is transported throughout the seed until it arrives at the aleurone layer that surrounds the endosperm. In the aleurone layer 1, the GA acts to turn on certain genes in the nuclear DNA. The genes are transcribed resulting in the creation of messenger RNA, which interacts with a ribosome to begin the process of protein synthesis, or translation. The result is the creation of a protein called amylase. The amylase is transported out from the aleurone cells and into the endosperm. The amylase is an enzyme that acts as a catalyst for the hydrolysis of starch into sugar.

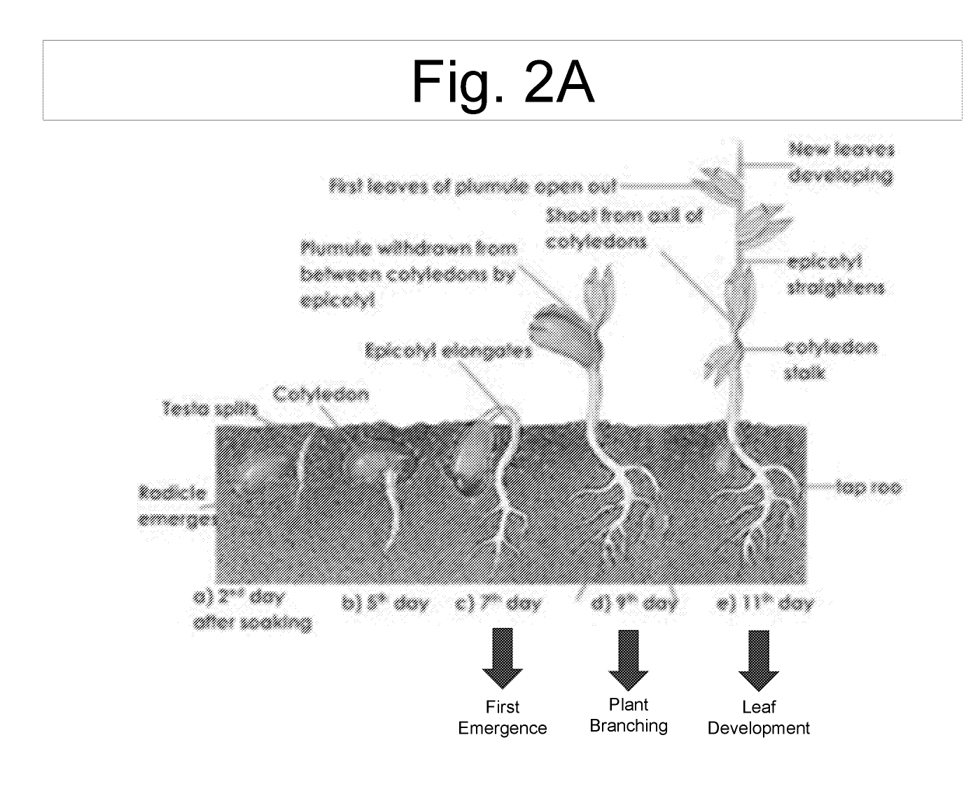

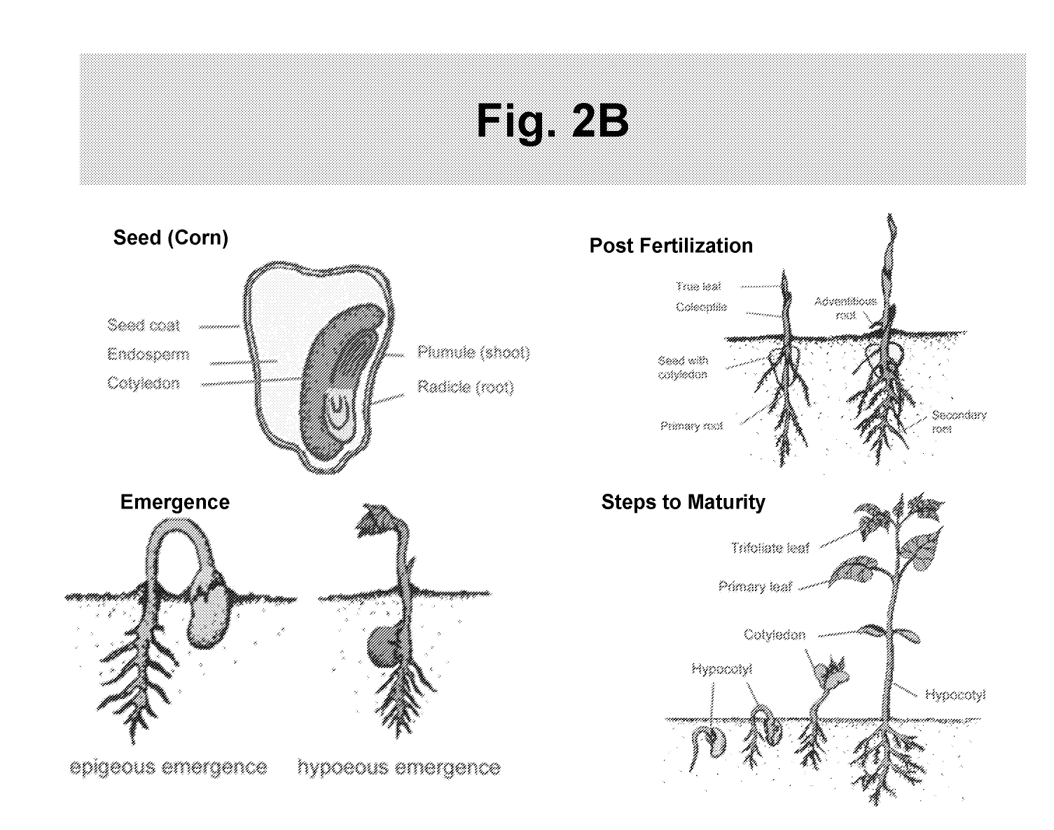

FIG. 2A illustrates the normal growth range from a germinated seed to a mature plant in the class of Dicotyledon, generally known as dicot, such as tomatoes, peas, peppers, roses and geraniums, among a great many others, to a developed plant. The text information on FIG. 2A is hereby incorporated into this description.

FIG. 2B is a depiction of the process of seed germination to a developed plant in the class Monocotolydeon, generally known as a monocot, such as wheat, oats, and corn, among a great many others. The text information on FIG. 2B is hereby incorporated into this description.

The goal of this invention is to reduce the time need to mature a plant, and thusly to reduce the time needed to harvest a particular crop, through the use of ultrasonic transmissions applied to the seeds. The process of the present invention applies to all types of plants, such as they decorative plants, plants for human or animal consumption, or plants for producing fuels, for example biofuels like ethanol, typically added to gasoline blends, for instance.

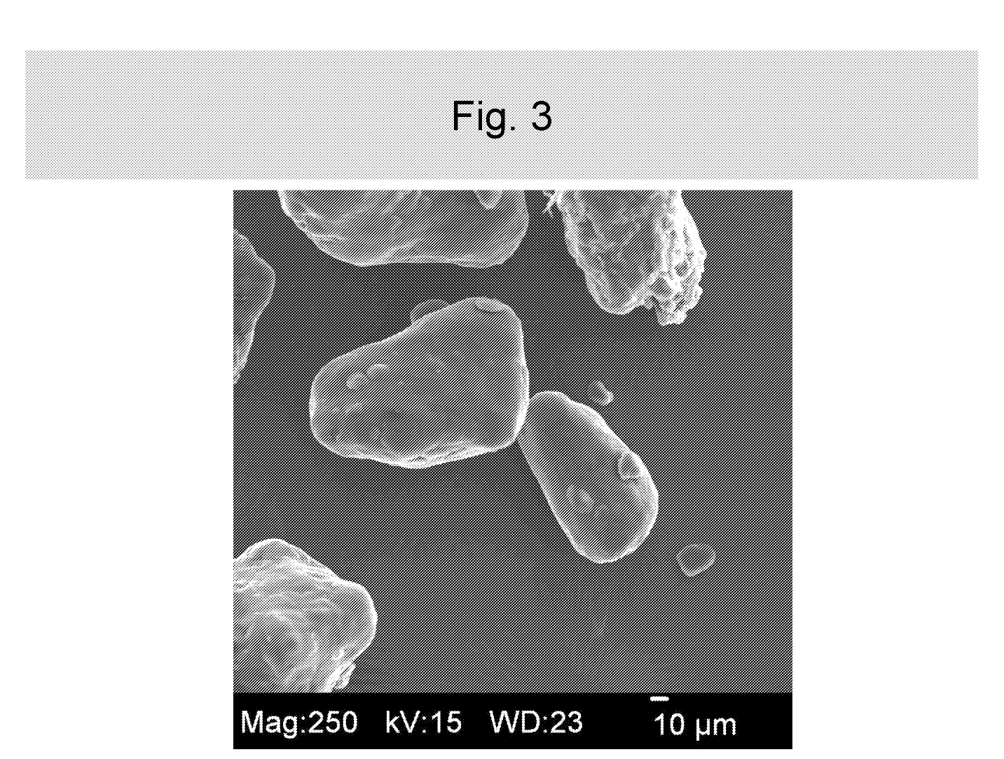

FIG. 3 is a scanning electron microphotograph of a collection of untreated, or raw, wheat seeds, which are small, all passing through a size 60 mesh screen (with openings of 0.0098 inch or 250 microns). FIG. 3 thus shows wheat seeds enlarged 250 times (250×) that have not been subjected to ultrasonic transmission, either by the process of the present invention or otherwise.

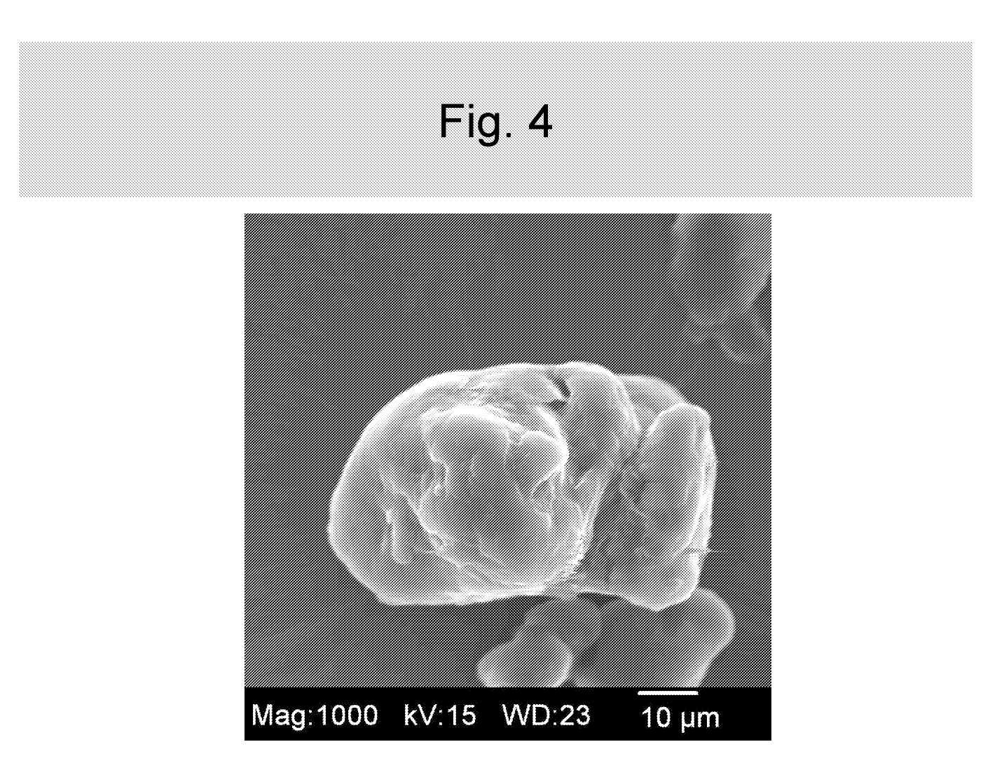

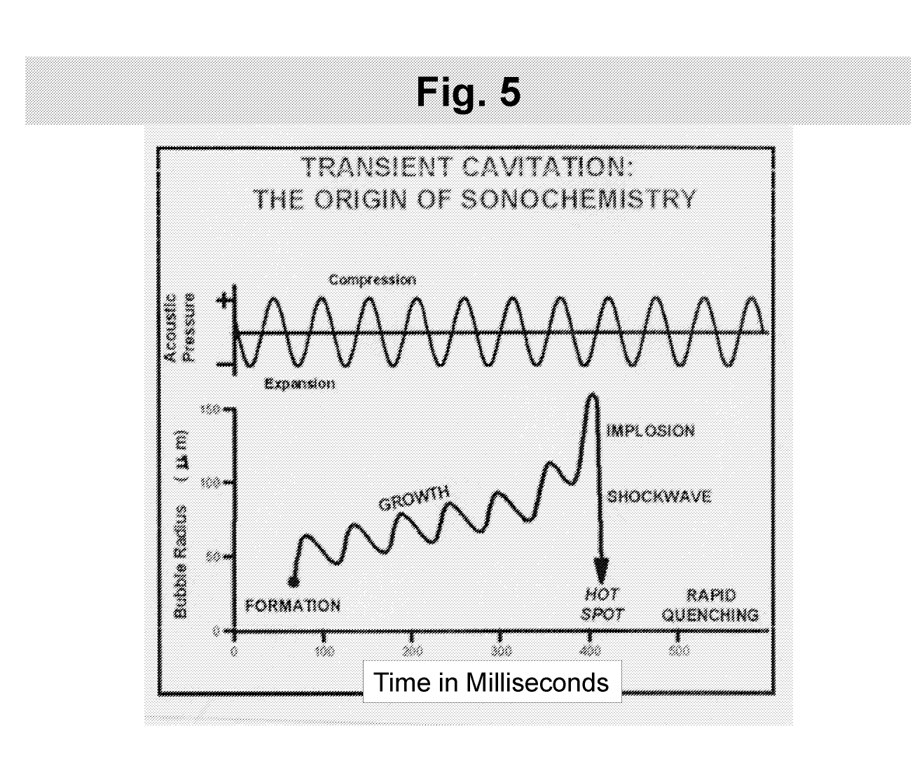

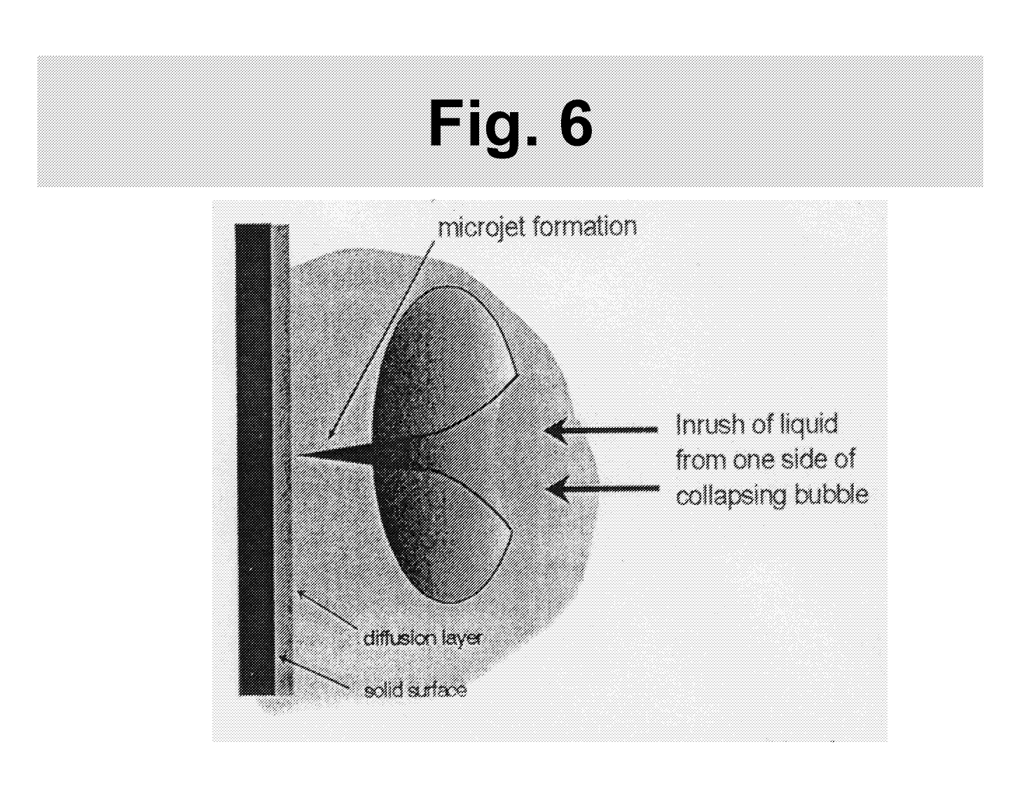

FIG. 4 is a scanning electron microphotograph of a collection of wheat seeds, similar to FIG. 3, but treated ultrasonically, where ordinary sinusoidal ultrasound or ultrasonic transmission, was applied to the seed for 5 minutes, showing that resultant cavitation has partially melted the seed. This cavitation effect is described regarding FIGS. 5 and 6.

FIG. 5 illustrates the effects of conventional ultrasound or ultrasonic transmission, in the development of intense heating effects caused by cavitation, which could damage the seed as shown in FIG. 4, where hot spots develop above 400 milliseconds with damage to seeds likely. The text information on FIG. 5 is hereby incorporated into this description.

FIG. 6 schematically illustrates an effect of cavitation with the development of micro-bubbles, which upon collapse, generate intense thermal effects, and unless controlled, can damage seeds. The text information on FIG. 6 is hereby incorporated into this description.

Since cavitation results in mechanical stress, sonication may create or enlarge fissures in the seed coat pericarp similar to scarification, a well-known process by which certain seeds, especially seeds with thick seed coats, are able to germinate. Scarification is believed to accelerate the imbibition of water through the pericarp. Simple scarification is unlikely to explain the novel effect disclosed herein, since scanning electron micrographs suggest no increase in the number of fissures in treated seed, but do indicate a change in pericarp texture. It has been found that the sonication process accelerates the imbibition of water. Cavitation may also result in physiological or biochemical changes in the seed that prime the germination process so that upon exposure of the seed to planting conditions, less time is needed for the seed to initiate germination, measured by the time when the radicle pushes through the pericarp. One mechanism proposed for causing physiological or biochemical changes is the production of free radicals by cavitation.

FIG. 5 illustrates, however, that ordinary ultrasonic cavitation resulting from ultrasonic transmission of sinusoidal waveforms can be injurious to seeds, by the indication of the implosion and shockwave portion of the bottom curve, which is substantially vertical. FIG. 4 is a microphotograph showing the effect of excess cavitation on a wheat seed enlarged 1000× exposed for 5 minutes to a sinusoidal ultrasonic waveform, a process known to create cavitation energies upon a sonic target. This cavitation caused the seed to melt and become inactive. In some instances, sinusoidal ultrasound may be beneficial in treating particular seeds, but it can also be demonstrated to be harmful in most instances of sonic application.

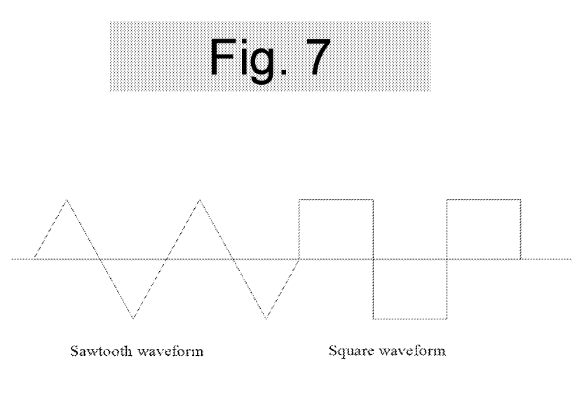

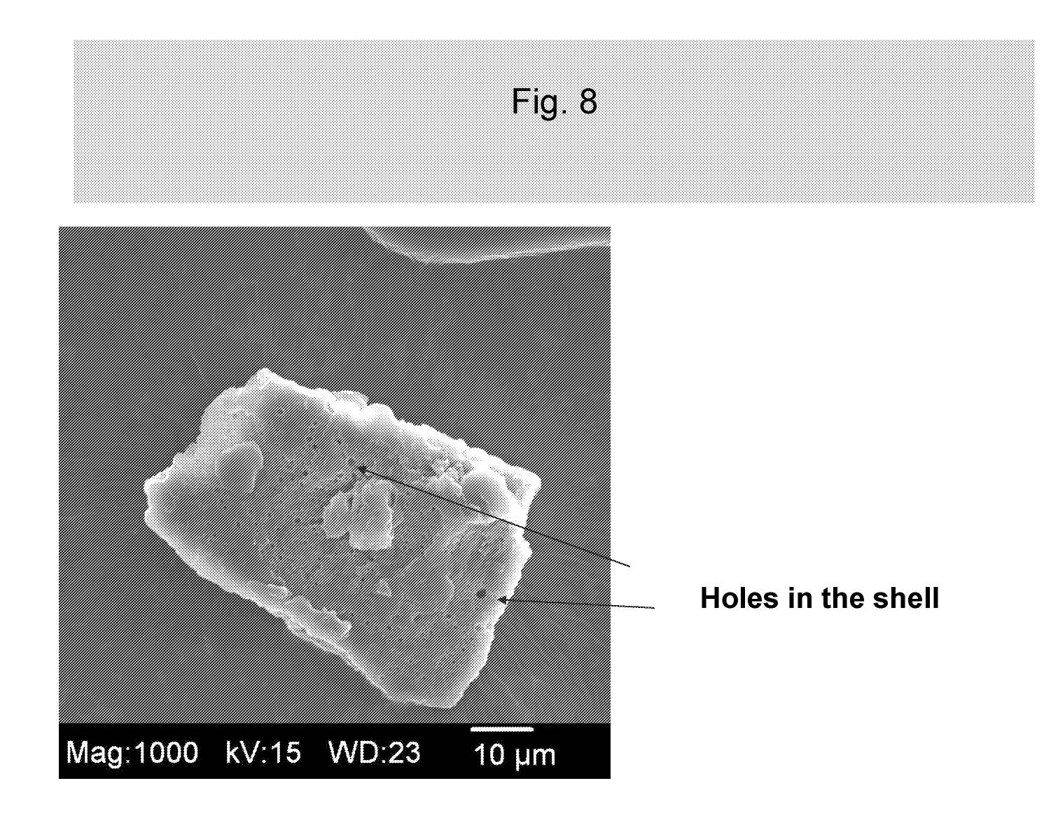

In view of the potential and actual damaging effects of cavitation on seeds, it is preferred to use the process of generating and maintaining ultrasonic transmission using alternating waveforms as depicted in FIG. 7, showing an exemplary sawtooth waveform applied and alternates with an exemplary square waveform, for reducing or eliminating cavitation, while maintaining the vibratory energy of ultrasound. The result of such ultrasonic transmission using alternating waveforms is shown in FIG. 8, where gentle perforations or small holes of the wheat seed shell layer have been demonstrated. FIG. 8 shows a wheat seed magnified 1000× where a sample of wheat seeds was treated with ultrasonic transmission for 20 minutes using transmissions of an ultrasonic sawtooth waveform for 50 milliseconds alternating with transmissions of square waveforms for 50 milliseconds. The treated seeds were dried and photographed. The ultrasonic transmissions penetrates the shell of the seed, leaving holes in the shell. The penetrations speed uptake of substances that enhance germination, such as water and nutrient solutions. Compared to the scanning electron microphotograph of raw wheat shown in FIG. 4, the alternating ultrasonic treatment has been found to be less damaging to the shell of the seed

### Process

As noted above and in the appended claims, several aspects of the present invention relate to a method or process for continuously treating seeds with ultrasonic transmission by continuously moving a flowable slurry of seeds for a length of a flow pipe through a helical path within the flow pipe. The flowable slurry is created by mixing seeds with a flowable medium to create a flowable slurry of seeds. The flowable medium to create the flowable slurry can be any time of gaseous or liquid flowable medium that does not damage the seeds. Thus, the flowable slurry need not be a liquid slurry as “slurry” is typically interpreted, but may also comprise seeds in The flowable medium can comprise air as an example of a gaseous medium and can comprise water as an example of a liquid medium.

One consideration in making the flowable slurry is the concentration or loading of the seeds with the flowable medium. For smaller seeds like tomato seeds, more seeds can be loaded than for larger seeds like corn or ginseng. The tradeoffs are the number of seeds ultrasonically treated, the ability to treat the seeds adequately as they travel continuously through the helical path in the flow pipe and the need to prevent clogging of the seeds as they travel through the helical path for the length of the flow pipe. The proper concentration can be readily determined without undue experimentation in view of this disclosure. In general, seeds are present in the flowable medium at a concentration of about 1% by weight to about 30% by weight, preferably at a concentration of about 5% by weight to about 30% by weight, and more preferably, at a concentration of about 30% by weight.

The transmission of ultrasonic energy to the seeds as they flow through the helical path is applied by ultrasonic transducers arranged along the length of the flow pipe. Various arrangements are suitable and some exemplary arrangements will be described below with respect to various embodiments of the apparatus of this invention. It is important that the seeds in the flowable slurry are subjected to the ultrasonic transmission having such waveforms and being transmitted in a manner so as not to damage the seeds and to produce ultrasonically-treated seeds that have regulated germination characteristics, such that plants resulting from the ultrasonically-treated seeds when the seeds are planted have affected growth characteristics.

Exemplary regulated germination characteristics can be enhanced germination characteristics to make the seeds germinate quicker, but those which retard germination until climate and soil conditions are more suitable for growth of plants based on the ultrasonically-treated seeds are also appropriate.

Some non-limiting examples of substances that may be included in the flowable slurry with the seeds to enhance germination are water, a fertilizer, a nutrient, a beneficial microorganism, a pest inhibitor, a hormone that promotes germination, a cytokinin that aids in cell elongation, or an inhibitor of abscisic acid that promotes release from a dormancy condition of the seeds, and any combinations thereof.

Some non-limiting examples of affected growth characteristics for plants resulting from the ultrasonically-treated seeds are any one or more of resistance to damage caused by a lack of sufficient water or excess water, regulated germination during cold temperatures, regulated germination during hot temperatures, and any combinations thereof.

Some non-limiting examples of substances that relate to the affected growth characteristics of such plants are those that the ultrasonically-treated seeds can take up into the treated seeds as the flowable slurry travels in the helical path along the length of the flow pipe of a substance in the flowable slurry, including a triazole that moderates the effects of the lack of sufficient water and high temperatures; a fungicide that inhibits growth of fungi on the ultrasonically-treated seeds or seedlings resulting from the ultrasonically-treated seeds in cool, wet soil; and a growth retardant to retard germination of the seeds or any plants resulting from the seeds.

To ultrasonically treat the seeds adequately, the time of treatment must be controlled. One way of doing so for the flowable slurry as it passes through the helical path along the length of the flow pipe is to control the flow rate. A slower flow rate assures greater exposure of the seeds to the ultrasonic transmissions from the transducers arranged along the length of the flow pipe, preferably on one, two or more sides of a flow pipe having sufficiently flat walls to better attach the transducers. A faster flow rate assures greater output of a larger number of ultrasonically-treated seeds, but must take into account the need for adequate ultrasonic transmission to the seeds. A good balance between an acceptable flow rate for production purposes and a sufficient time for the seeds to be subject to the ultrasonic transmission is a flow rate of the flowable slurry of about 0.2 inch (0.51 cm) per second to about 1 inch (2.54 cm) per second, preferably about 0.3 inch (0.76 cm) per second to about 1 inch (2.54 cm) per second, and in a presently preferred embodiment, a flow rate of about 0.33 inch (0.84 cm) per second. The size and type of seeds being ultrasonically treated, their concentration, the nature of the flowable medium to create the flowable slurry and the nature, type and manner of the ultrasonic transmission all affect the flow rate or other measurement of time during which the seeds are adequately treated ultrasonically. One skilled in the art can determine suitable timing based on this disclosure without undue experimentation.

Another factor in the continuous process of the present invention is the frequency of the ultrasonic transmissions. Suitable frequencies have been determined to be about 15 KHz to about 175 KHz, preferably about 15 KHz to about 100 KHz, and more preferably about 20 KHz to about 23 KHz. Again, the nature and concentration of the seeds in the flowable slurry, and other parameters have to be balanced, which can be achieved without undue experimentation in view of this disclosure.

The energy density, sometimes referred to as energy intensity, of the ultrasonic transmissions is also a consideration in the appropriate ultrasonic treatment of the seeds. Acceptable energy densities are about 0.125 watt/cm² to about 10 watts/cm², preferably about 0.225 watt/cm² to about 10 watts/cm², and more preferably about 0.5 watt/cm². As before, an appropriate balancing of all other parameters with the energy density should be taken into account.

The type and manner of application of ultrasonic transmission waveforms to the flowable slurry of seeds are also factors. As mentioned earlier, cavitation may sometimes be beneficial, particularly where the seeds and their hulls and shells are thick. However, as also explained earlier, the use of alternating ultrasonic transmission waveforms reduce or eliminate cavitation and the potential damage that it causes to seeds, and is preferred.

Suitable ultrasonic waveforms may be sinusoidal, triangular, sawtooth and square. Alternating sawtooth waveform followed by square waveform is the preferred manner of applying the ultrasonic transmission. The times for each waveform type to be applied can vary from about 10 milliseconds (msec) to 400 msec. Above 400 msec, particularly when sinusoidal waveforms are used, there is a likelihood of seed damage due to implosion and a created shockwave as shown in FIG. 5, so the time of applying alternating waveforms should be kept below 400 msec. Preferred times for each waveform type to be applied are from about 20 milliseconds (msec) to about 200 msec. A presently more preferred timing for each waveform type to be applied is about 50 msec, especially when a sawtooth waveform is applied, followed by a square waveform.

Since the ultrasonically-treated seeds retain their memory for regulatory substance uptake, imbibition or other beneficial results, and since the ultrasonically-treated seeds are sold in a dry condition, often after considerable storage, the process of this invention also includes drying the seeds to remove any liquid flowable medium from the treated seeds, before typically storing and shipping the ultrasonically-treated seeds.

An optional, but desirable intermediate aspect of the process is filtering the ultrasonically-treated seeds from the flowable medium used to create the flowable slurry, before the seeds are dried. This usually quickens the drying process by removing excess liquid flowable medium.

Other aspects and considerations for continuously processing the seeds with ultrasonic transmission will become apparent to those skilled in the art in view of this description, and particularly when considering the description and explanation of the apparatus of the invention, especially together with the accompanying drawings.

### Apparatus

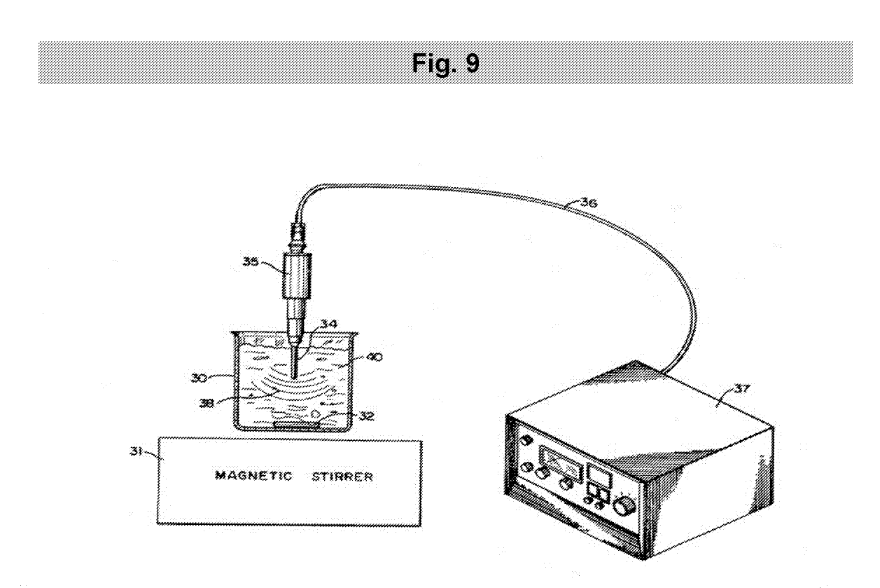

One known embodiment of apparatus used in the ultrasonic treatment of seeds in a batch process is illustrated diagrammatically in FIG. 9, for purposes of explaining some background concepts useful to understand with respect to the continuous process of ultrasonically treating the flowable slurry in a helical path according to the present invention. FIG. 9 illustrates a laboratory treatment process where upon a quantity of seeds are placed within a beaker or vessel 30. A sonic probe 35, powered by an ultrasonic generator 37, is placed within the water 40 and connected to a sonic tip 34 which develops a sonic transmission 38 through the water to the seeds which are immersed within the water. The power cable 36 from the generator carries an electronic transmission to the transducer tip 34, which ideally provides an alternating ultrasonic transmission, such as depicted in FIG. 7. Within the vessel is a magnetic stir bar 32 which circulates the seeds within the vessel. Shown is a magnetic stirring instrument 31 which causes the stir bar to rotate the seeds undergoing the ultrasonic transmission 38.

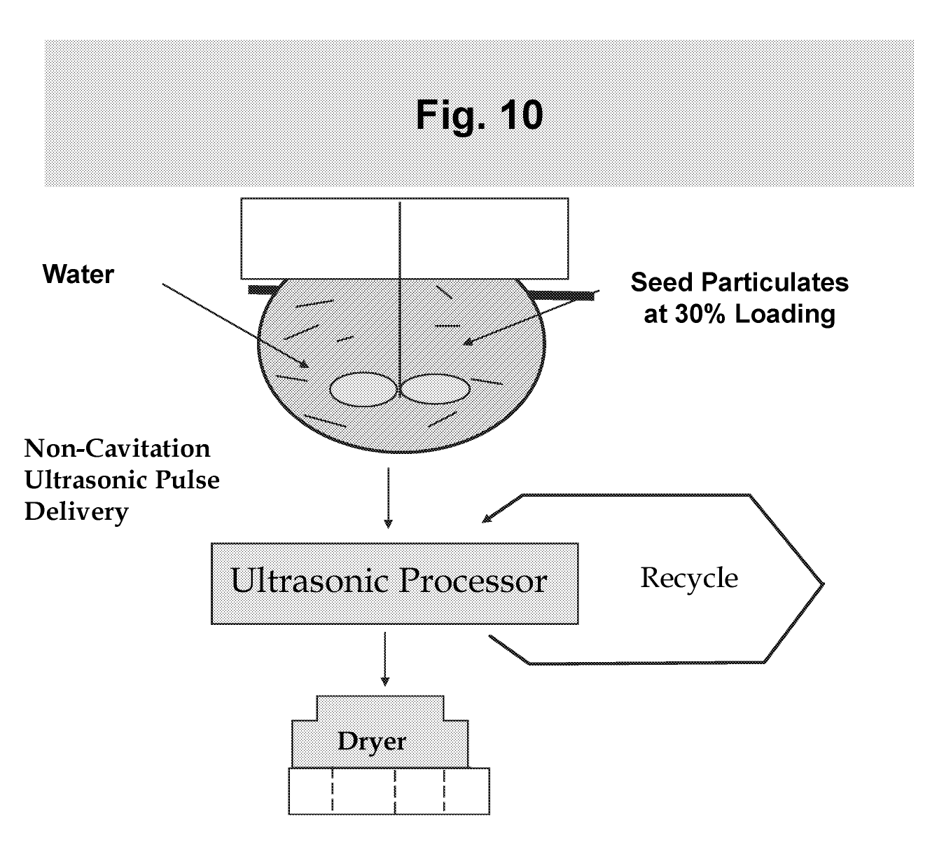

The next scale up in the development process toward the present invention for continuously treating seed in a helical path was a larger device which treated seeds ultrasonically in a much larger batch process, as shown in FIG. 10. Here, water is placed in a tank loaded with seeds from about 1% by weight to about 30% by weight, and closer to 30% by weight. The slurry is stirred and then delivered to an ultrasonic processor device to treat the seeds, and provide for multiple treatment cycles before the treated seeds are conveyed to a filter and then a dryer to produce dry seeds.

While the apparatus shown in FIG. 10 was effective in demonstrating the concept of sonically treated seeds and was superior to the laboratory apparatus, it was still a batch load system and inherently was more expensive to operate than would be a continuous processing apparatus, and particularly the apparatus of the present invention. The text information on FIG. 1 is hereby incorporated into this description.

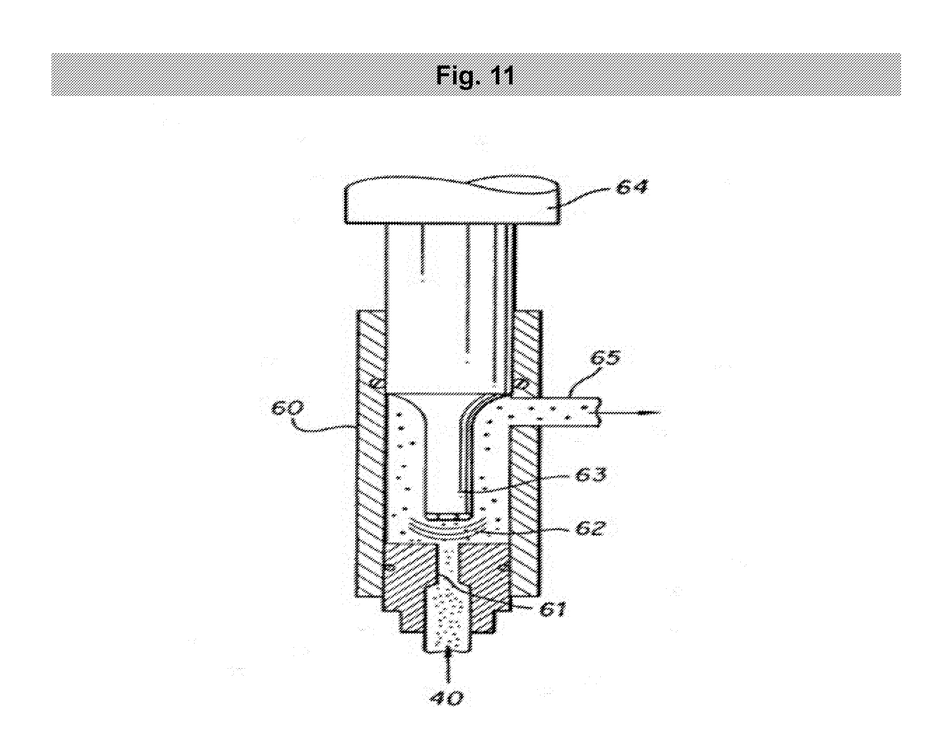

FIG. 11 is an illustration of an ultrasonic flow cell system for treating seeds with ultrasound. In this design a continuous process for the ultrasonic treatment of seeds is shown. Seeds 40 enter the flow cell 60 and are constricted to a narrow tube 61 which directs the seeds directly under an ultrasonic transmission 62 emanating from an ultrasonic transducer assembly 63. The seeds are immersed in water at an average solids content of about 30%, but alternatively could be pushed by compressed air within the cell 60. Ultrasound is directed from the ultrasonic probe 64 which is fitted into the cell 60. The seeds flow upwards and against the ultrasonic transducer assembly 63, are sonically treated, and then flow from the cell through an exit pipe 65.

While the device illustrated in FIG. 11 was functional, the seeds tended in experiments to be sonically treated on one side and for a short duration as they flowed past the ultrasonic transducer assembly 63.

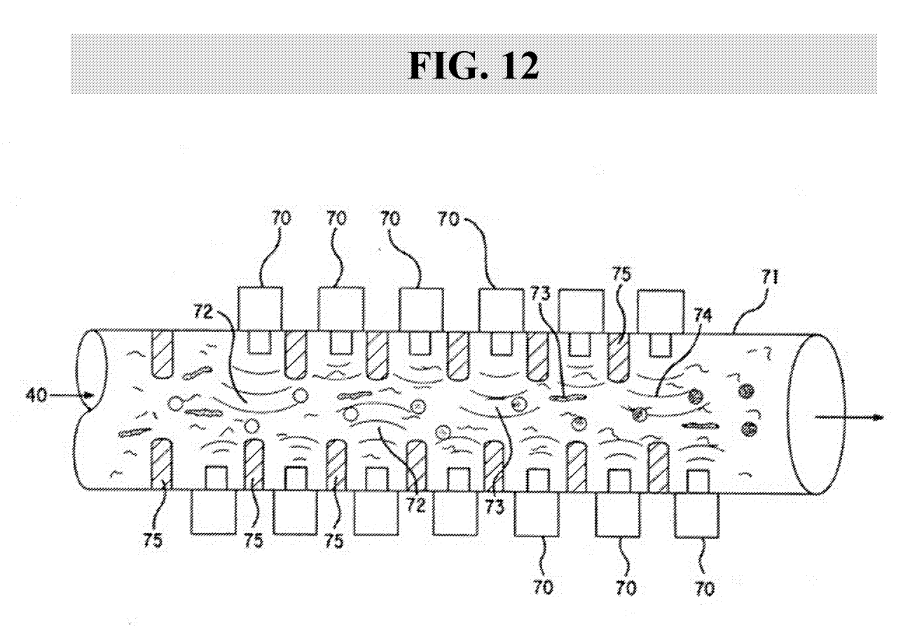

FIG. 12 is a schematic illustration of an ultrasonic pipe cell system for treating seeds with ultrasound on another type of continuous basis. The seed slurry 40 is passed through an ultrasonic flow pipe 71. Placed within the pipe are a series of baffles 75 which induce turbulence within the pipe and cause the seeds within the flow to rotate and tumble 73, but not in a helical path. Moreover, especially since the series of baffles is not in a helical path or even more so not in a smooth helical path, the seeds that impact the baffles from all angles within the pipe tend to become damaged to a significant extent. A series of transducers on the outer wall of the pipe or as part of a transducer sleeve 70 placed around the pipe transmit ultrasound 72 across the entire length of the flow pipe 71. The treated seeds 74 exit the flow pipe 71. In this design for a continuous ultrasonic treatment of seeds, the seeds 40 are forced to rotate within the pipe 71, by interacting with the baffles 75. The time for ultrasonic exposure to the seeds can be varied by the flow rate of the seed slurry through the pipe and the length of the pipe. The intensity of the ultrasonic transmission 72 can be varied and adjusted in power output according to the needs of an individual seed species.

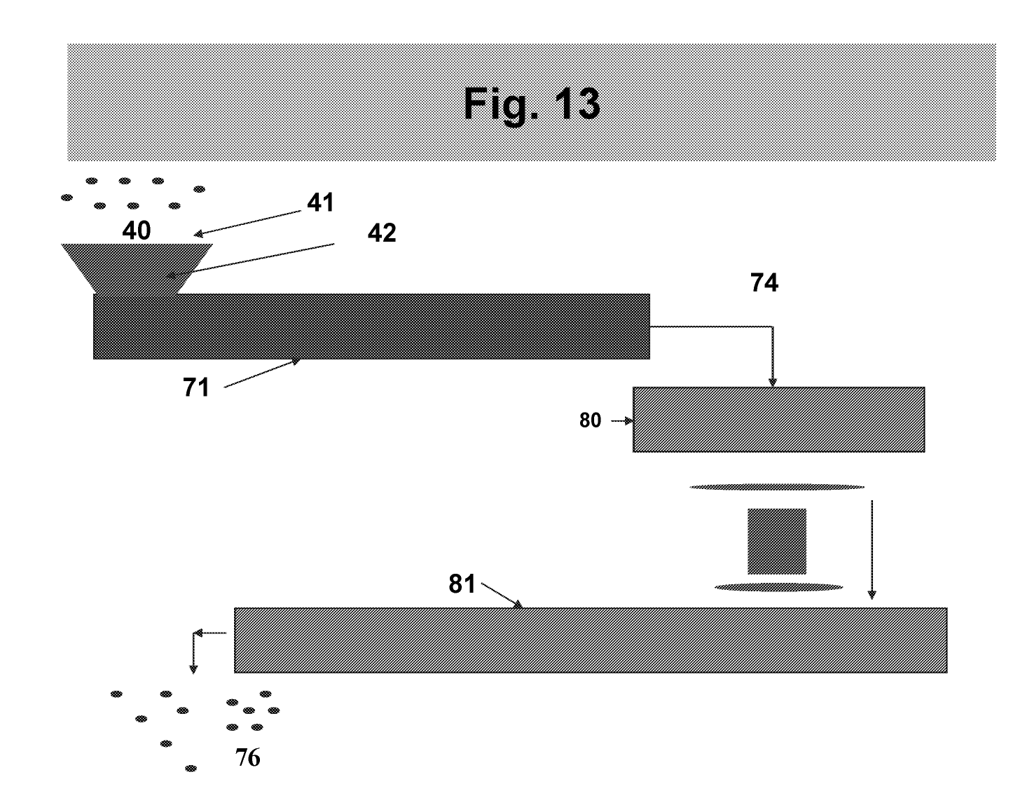

FIG. 13 is a schematic illustration of an ultrasonic pipe cell system for treating seeds with ultrasound, followed by a filtration system leading to a drier for removing moisture from ultrasonically treated seeds. Raw Seeds 40 are mixed with water or a nutrient solution 41 in a tank or hopper 42 and then flow into the ultrasonic flow pipe 71 described in FIG. 12. The ultrasonically treated seeds 74 exit the flow pipe 71 and pass through filtration to separate the seeds from the water carrier. From there the remaining moisture is removed by a commercial dryer 81 and the final dried seeds 76 are delivered to packaging.

While the device illustrated in FIGS. 12 and 13 was functional the overall length of the continuous flow pipe system was quite large.

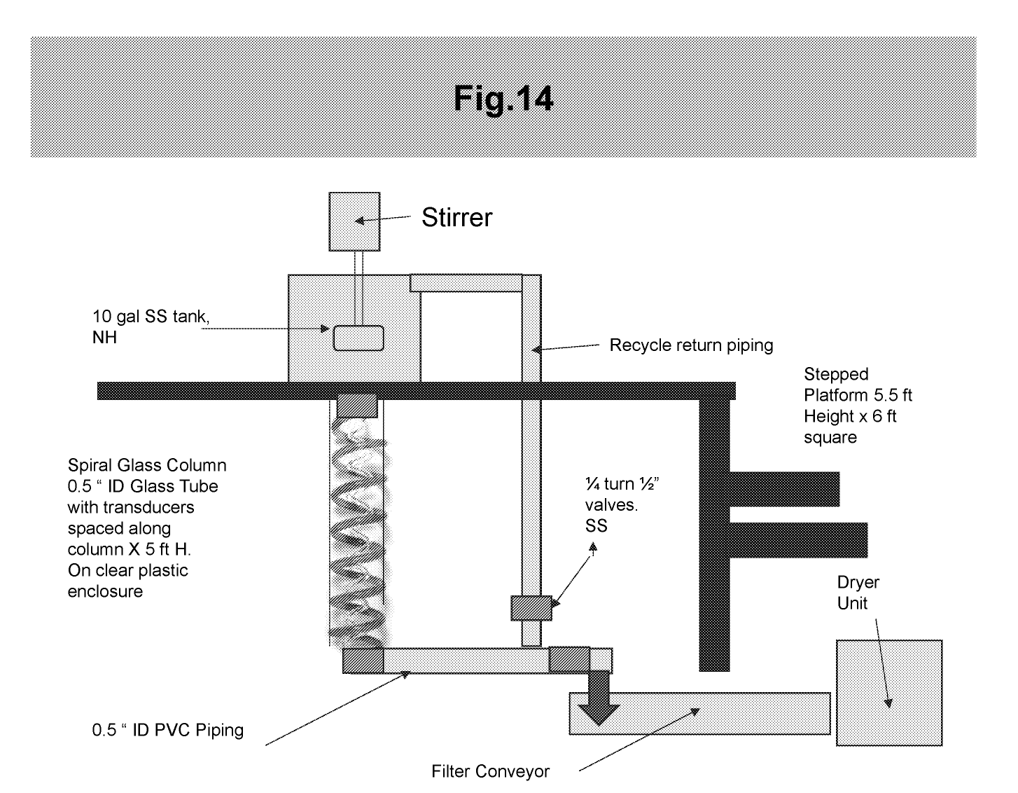

FIG. 14 is a schematic illustration of one embodiment of a continuous ultrasonic system for treating seeds with ultrasound according to the present invention, involving a spiral or helical seed slurry flow tube design, followed by a filtration system leading to a drier for removing moisture from ultrasonically treated seeds. This design employs spiral or helical tubing within a flow pipe which greatly reduced the length of the treatment flow pipe depicted in FIGS. 12 and 13. The text information shown on FIG. 14 is hereby incorporated into this written description, and is merely exemplary of materials and dimensions, which are not critical to the invention.

Instead of an internal spiral or helical seed slurry flow pipe within an exterior flow pipe, a continuous ultrasonic apparatus could use an internal series of baffles in a helical path, and more specifically baffles along the interior wall of the flow pipe in the manner of a smooth internal helical or spiral screw surface. This would still likely have a long length, but the helical path and especially a smooth internal helical path would alleviate to some degree damage to the seeds from impacting a number of baffles arranged to extend perpendicularly from the flow pipe's inner walls, as shown in FIG. 12.

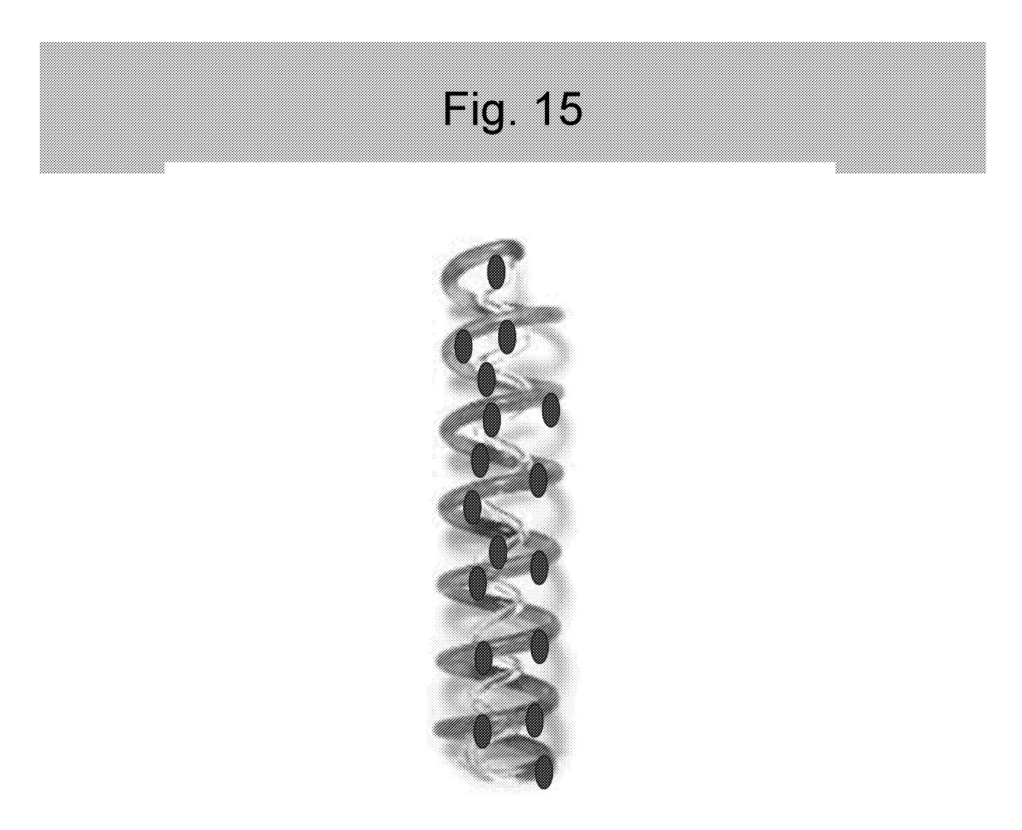

FIG. 15 is a schematic illustration of a continuous ultrasonic system for treating seeds with ultrasound, involving a spiral or helical slurry flow pipe design, whereupon ultrasonic transducers are affixed directly to exterior of the helical tubing. Seeds travelling through the helix automatically rotate within the tubing and are exposed on all sides as they travel the length. The use of baffles is eliminated in this design. The spiral or helical tube provides soft gentle turning of the seeds within the ultrasonic treatment field. As noted above, baffles impacting with seeds in the slurry could damage the seeds. The use of the helical tube through which the seed slurry travels spiral both provides non-damaging seed rotation and shortens the overall length of the treatment machine.

FIG. 16 is an illustration of an embodiment of a helical path flow tube which rotates seeds as they are traveling through the helical or spiral unit in a continuous ultrasonic system for treating seeds with ultrasound. The text information shown on FIG. 16 is hereby incorporated into this written description, and is merely exemplary of dimensions, which are not critical to the invention.

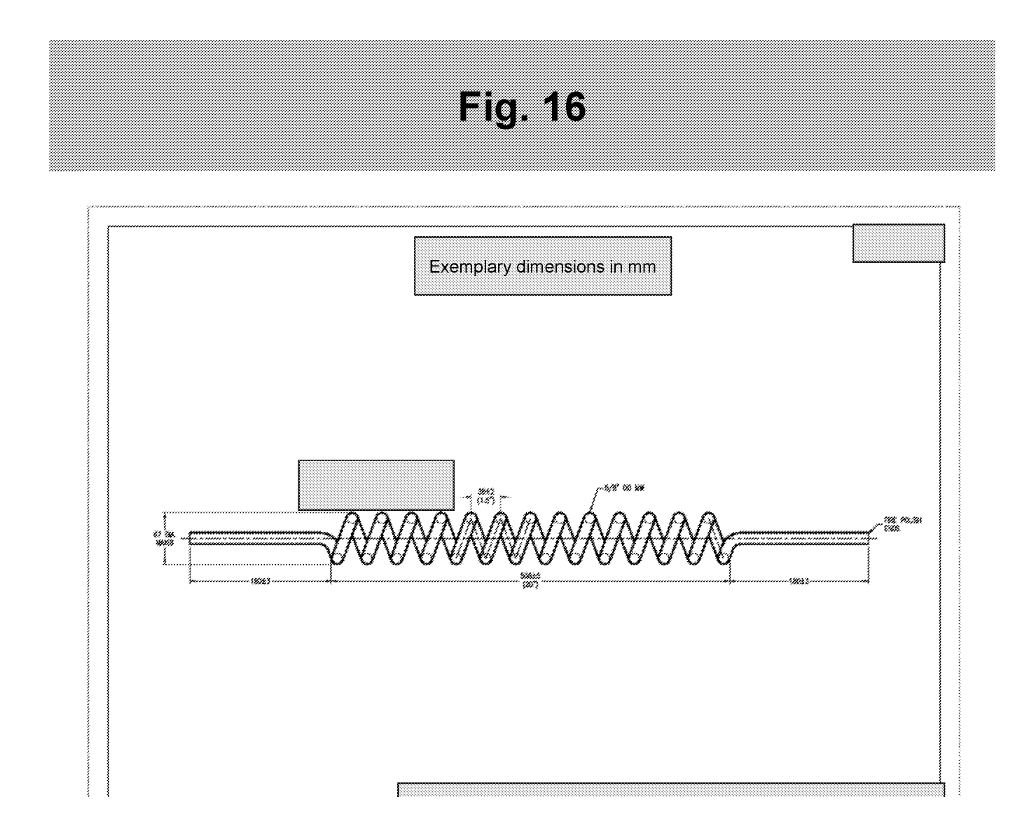

FIG. 17 is an illustration of a jacket or cover which fits over and around the spiral or helical flow pipe design illustrated in FIG. 16. The jacket or cover essentially forms the external flow pipe as identified in the description of the broader aspects of this invention, since the flowable slurry of seeds does flow indirectly through the jacket or cover while the flowable slurry flows directly through the interior of the helical tube, which is inside of the jacket or cover. This drawing illustrates the jacket or cover which can be loaded with water or other liquid medium (sometimes referred to herein as the second medium). This second medium can be either cold or warm water, or other liquid, such as an oil, like silicone oil, and will allow the ultrasonic transmission from transducers placed on the exterior, or alternatively within the jacket or cover to ultrasonically treat seeds which flow within the helical tubing and which rotate as they are traveling through the helical tubing. Oil generally is easier to heat or cool than water, so that if a temperature-adjusted liquid second medium is desired, oil would be a preferred embodiment.

The jacket or cover and the helical tubing may be made of quartz glass, as in the case of the illustrated laboratory model, to allow ultrasonic transmission to pass through their walls and through the second medium to ultrasonically treat the seeds in the flowable slurry within the helical tube, which, in turn is within the flow pipe jacket or cover. Other more durable materials may be used, so long as the ultrasonic transmission can pass through the walls and through the second medium to ultrasonically treat the seeds in the flowable slurry within the helical tube, which, in turn is within the flow pipe jacket or cover. A suitable, non-limiting exemplary material is stainless steel.

Preferably, but not critically, the jacket or cover has a square cross-section as shown in the separate sectional view of FIG. 17, so that the ultrasonic transducers may be more readily and securely attached to substantially flat walls and at least partially surround the helical tube, as shown and described in later drawings. This cross-sectional shape also allows the ultrasonic transducers to be equidistant from the central longitudinal access of the jacket or cover and from the helical tube within the jacket or cover, for even application of ultrasonic transmission to the flowable slurry of seeds in the helical tube.

The text information shown on FIG. 17 is hereby incorporated into this written description, and is merely exemplary of materials and dimensions, which are not critical to the invention.

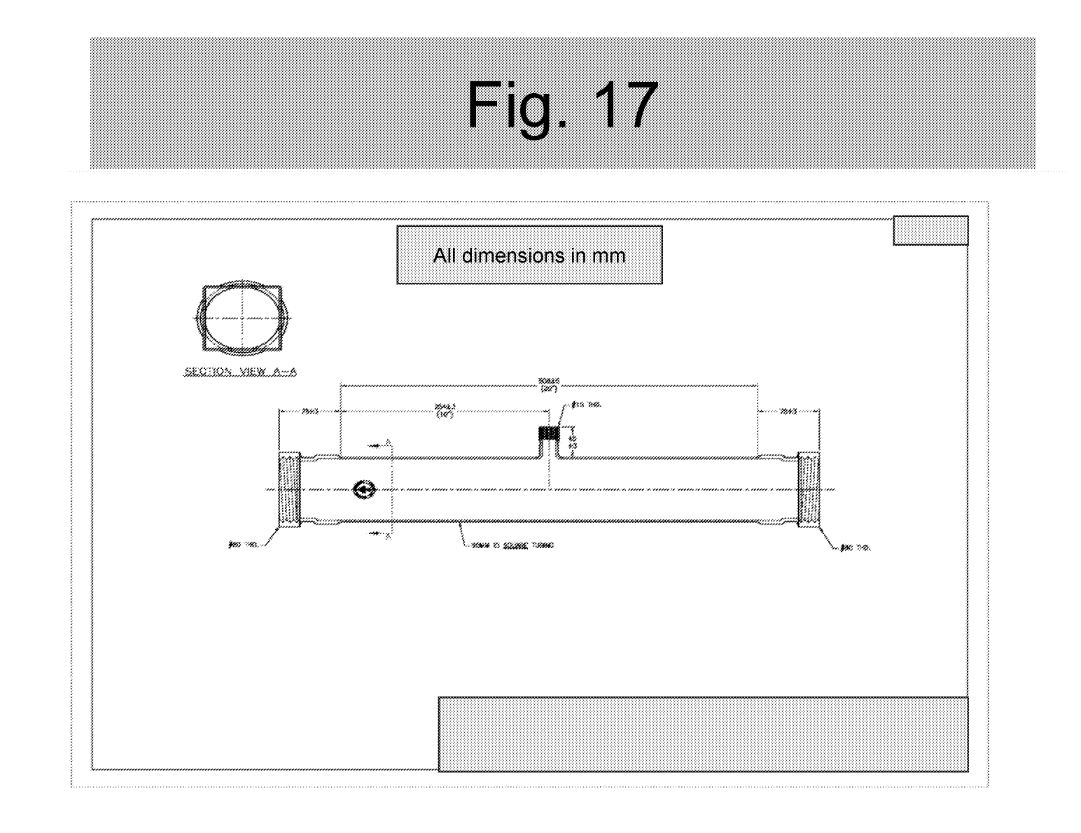

FIG. 18 is an illustration of the embodiments of an apparatus for the ultrasonic treatment of seeds in a continuous processing system, which includes the flow pipe jacket or cover of FIG. 17 over and around the internal spiral or helical flow pipe design illustrated in FIG. 16. There are end caps that screw into both ends of the flow pipe jacket or cover that support the ends of the internal spiral or helical tubing within the flow pipe. The text information shown on FIG. 18 is hereby incorporated into this written description, and is merely exemplary of materials and dimensions, which are not critical to the invention.

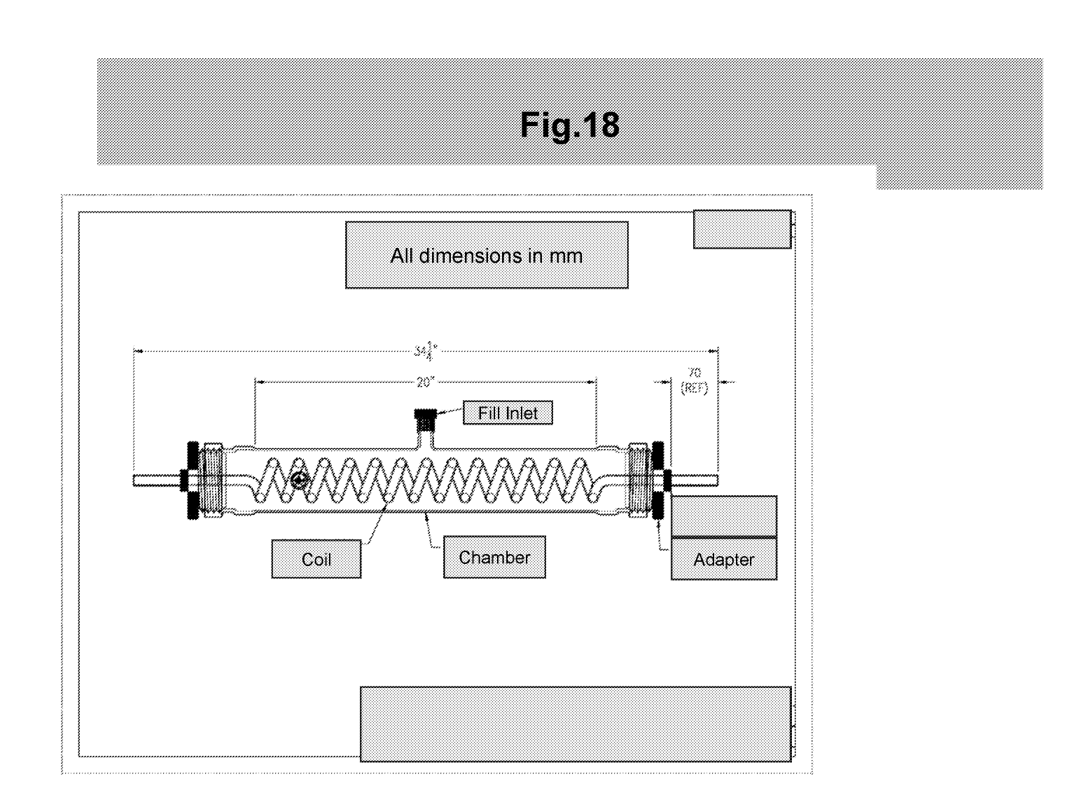

FIG. 19 is an illustration of details of the end caps shown in FIG. 18, which fit into the ends of the flow pipe jacket or cover and support the ends of the internal spiral or helical tubing device for the continuous treatment of seeds ultrasonically. The end caps may be made of nylon or other plastic that is durable and retains its shape and firmly can retain the ends of the helical tube within the jacket or cover. The text information shown on FIG. 19 is hereby incorporated into this written description, and is merely exemplary of materials and dimensions, which are not critical to the invention.

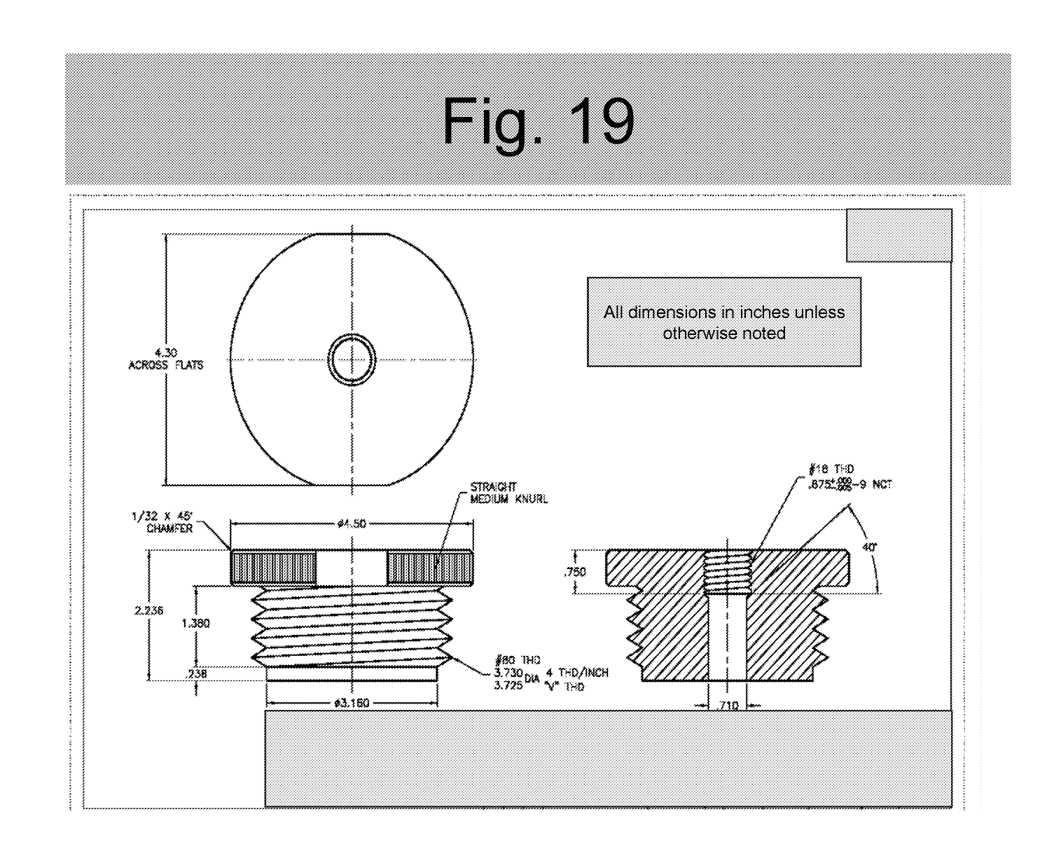

FIG. 20 is a photograph of a continuous ultrasonic system for treating seeds that illustrates a conveyor in the form of a pump for pumping the flowable slurry of seeds through the helical tube. FIG. 20 also shows the placement of ultrasonic transducers on the exterior of the flow pipe jacket or cover with the square cross-section shown in FIG. 18 and along its length. The spiral or helical tube creating the helical path for the flowable slurry of seeds is inside the flow pipe. The text information shown on FIG. 19 is hereby incorporated into this written description.

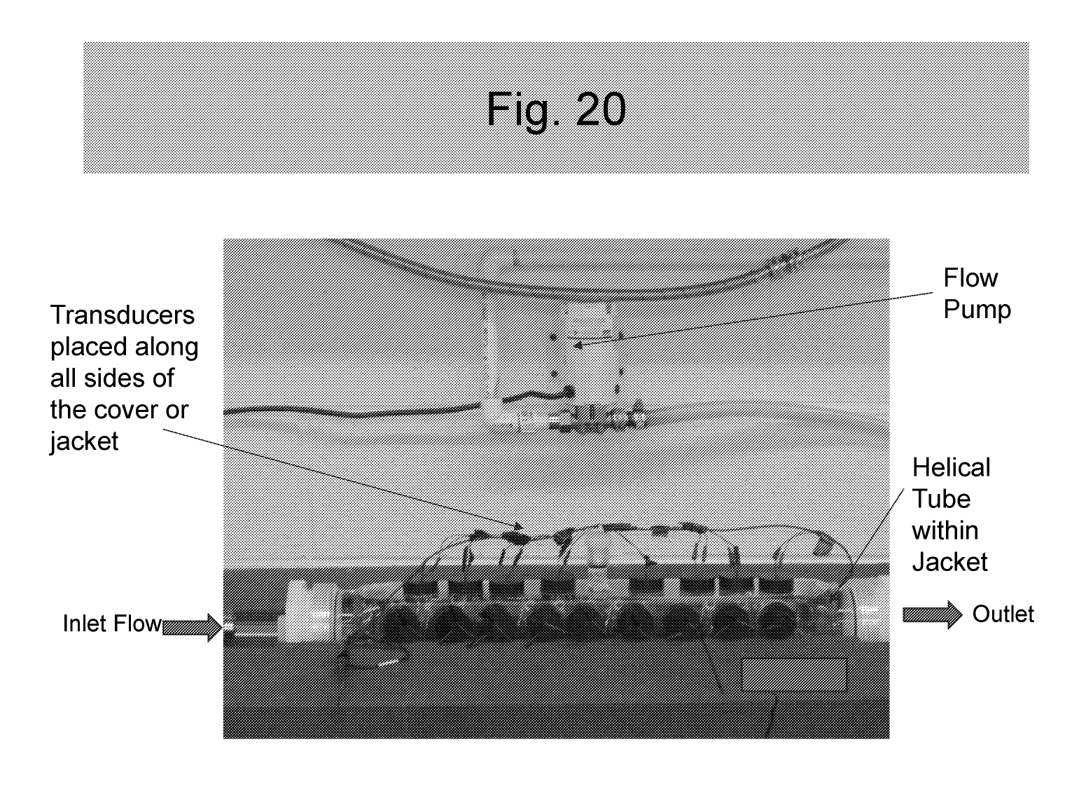

FIG. 21 is a photograph showing another view of the flow pipe having a square cross-section as shown in FIG. 18, held within a stabilizing base, and assembled with the end caps of FIGS. 18 and 19 and with the internal helical path as shown in FIGS. 16 and 18 for the flowable slurry of seeds within the flow pipe. This assembly shows the continuous processor system used in the experiments set forth below.

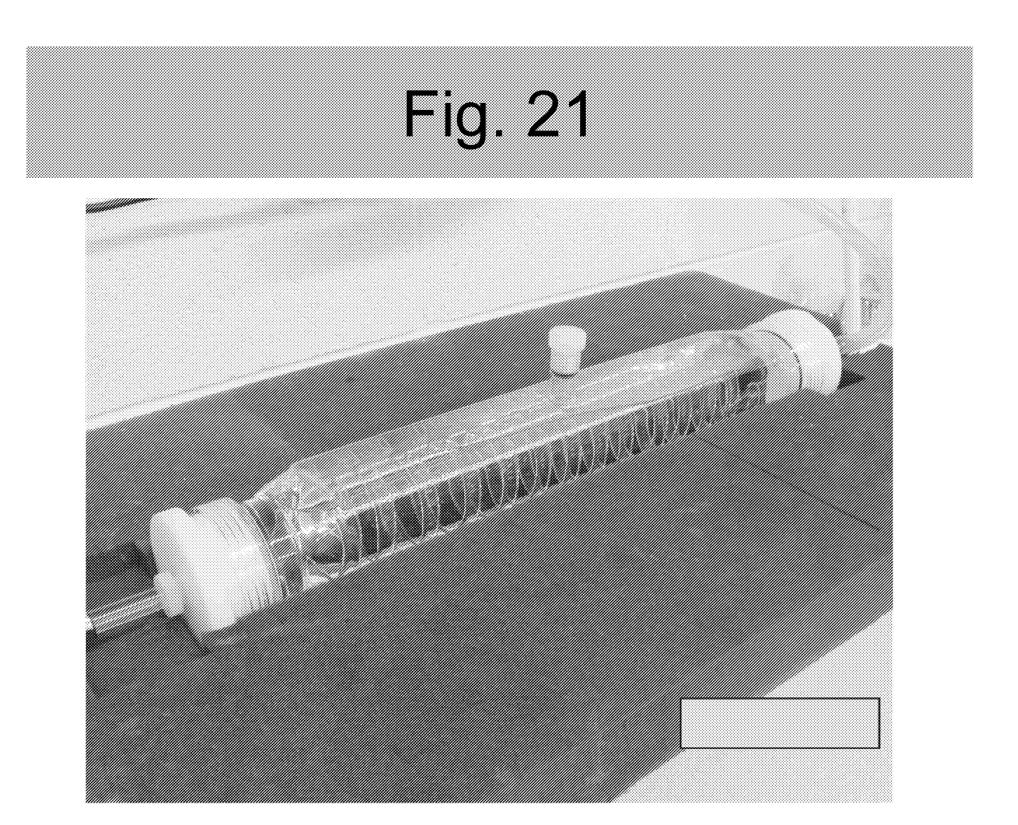

FIG. 22 is a photograph showing another view of the flow pipe having a square cross-section as shown in FIG. 18, held within a stabilizing base, with ultrasonic transducers externally affixed to sides and along the length of the flow pipe, and assembled with the end caps of FIGS. 18 and 19 and with the internal helical path as shown in FIGS. 16 and 18 for the flowable slurry of seeds within the flow pipe. This assembly shows the continuous processor system including the flow pump for the flowable slurry of seeds and tubing connected to the helical flow tubing at the outlet end and tubing connected to a source of seeds in the form of a seed tank containing the a flowable slurry of seeds as used in the experiments set forth below. The text information shown on FIG. 22 is hereby incorporated into this written description.

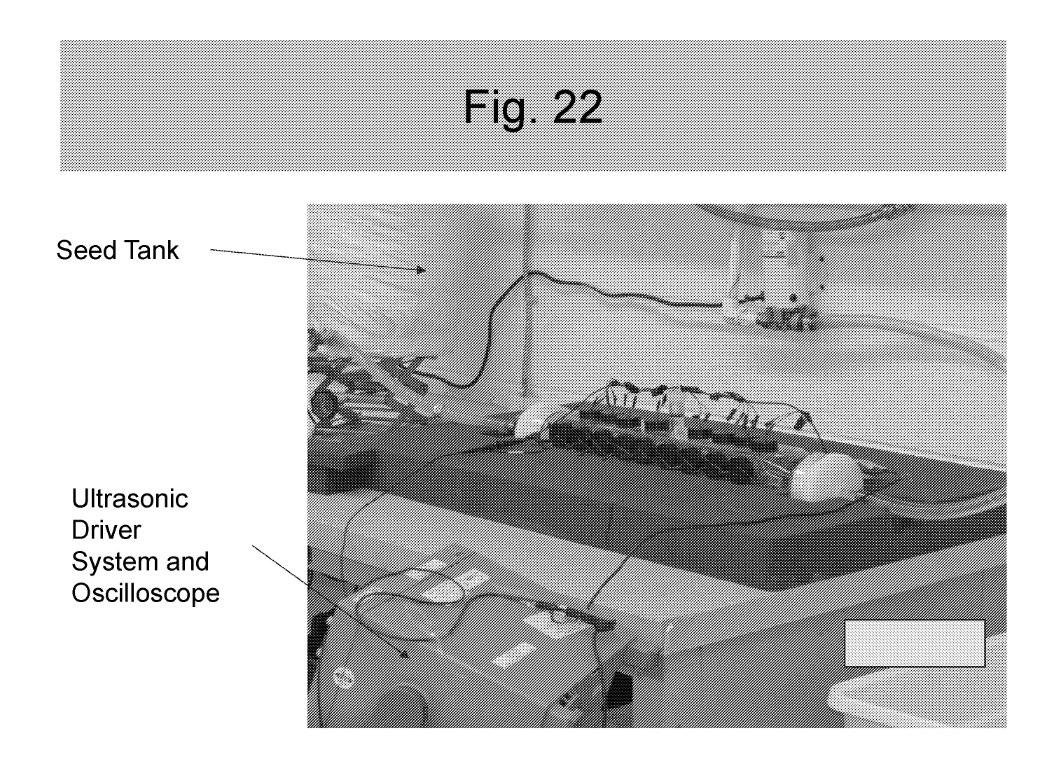

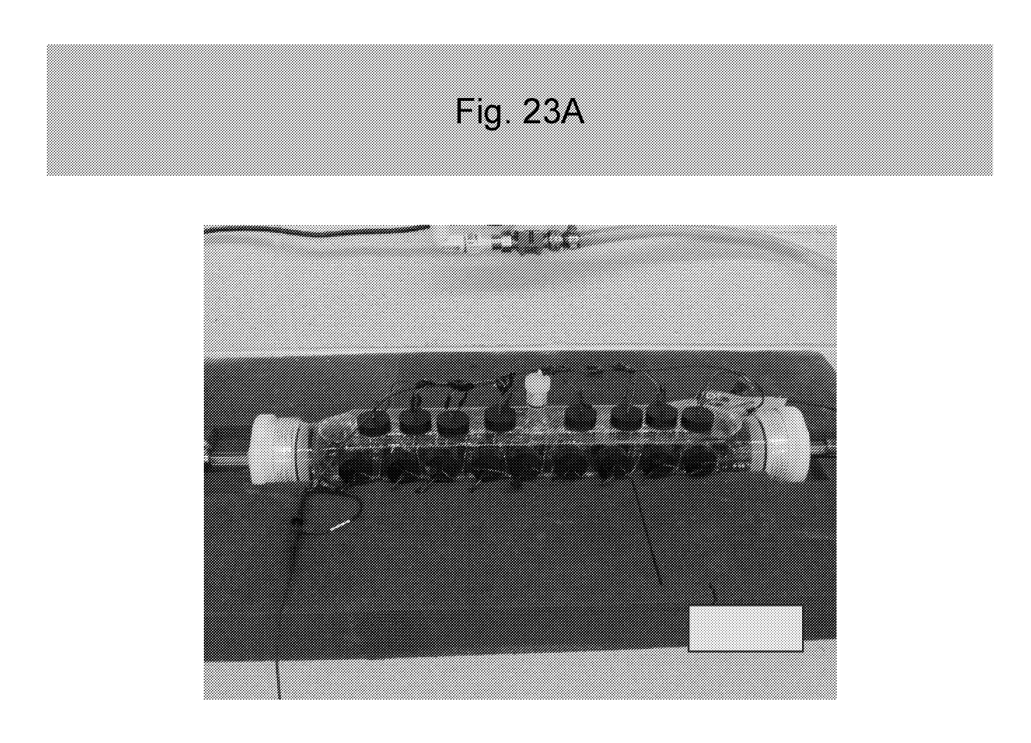

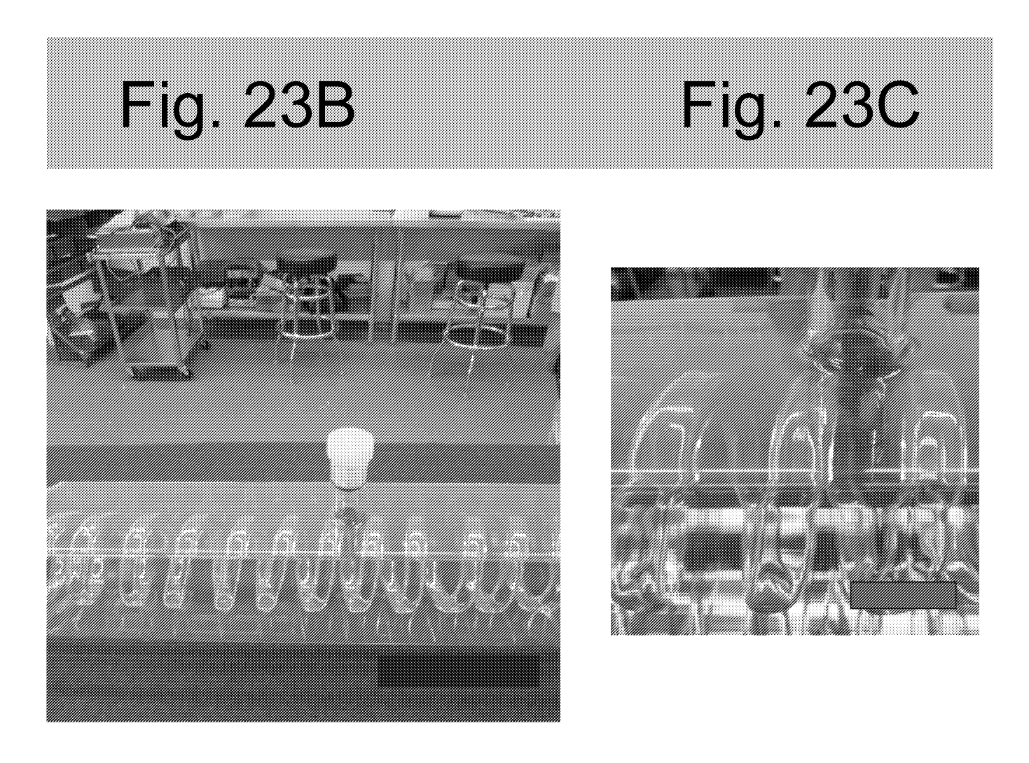

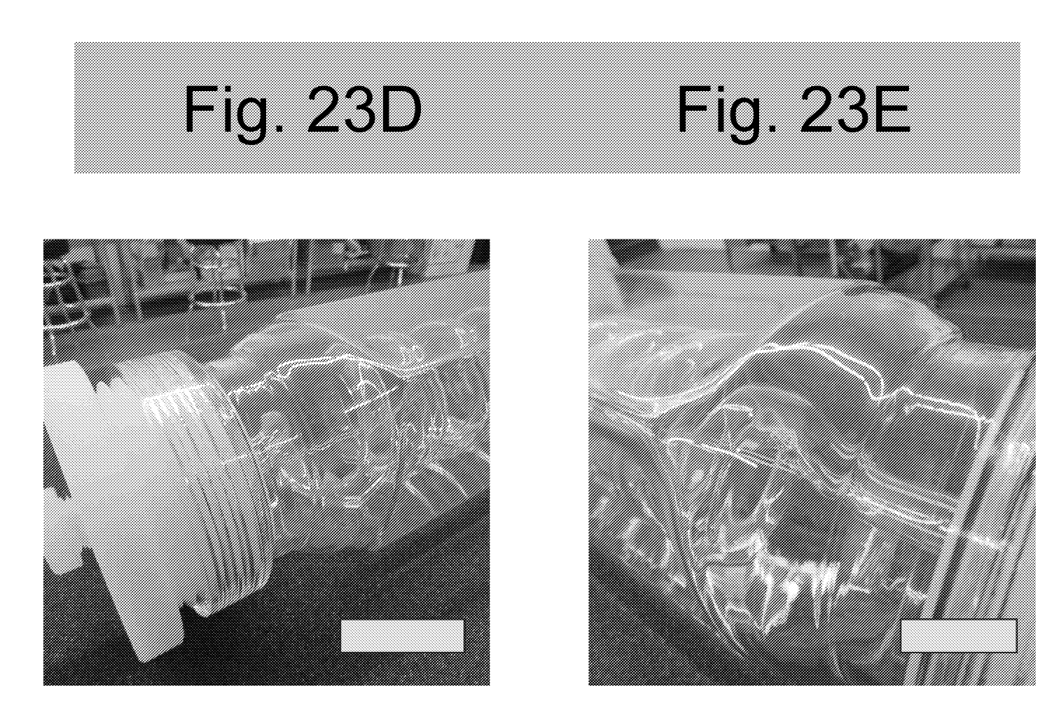

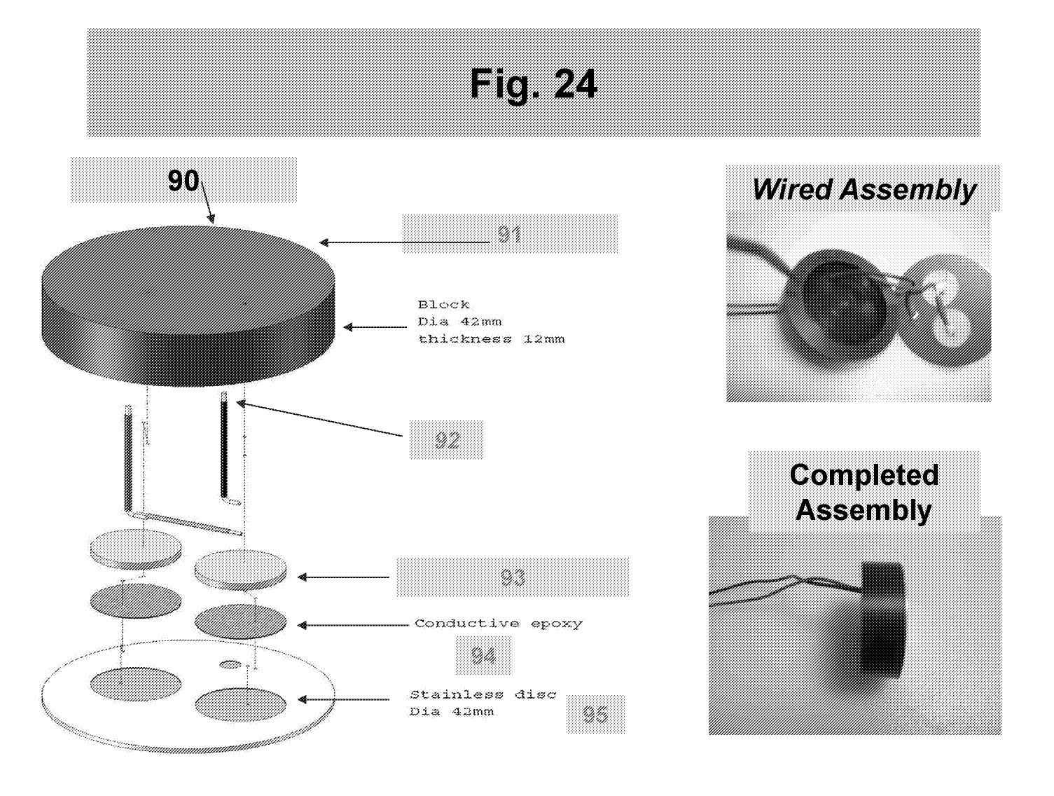

FIG. 23A is a photograph showing an enlarged view of the flow pipe of FIG. 22.

FIG. 23B is a photograph showing an enlarged view of the flow pipe of FIG. 21 and most of the internal helical flow tube for the flowable slurry of seeds, as well as a sealable port for a liquid second medium to be within the flow pipe jacket or cover and around the internal helical flow tube for the flowable slurry of seeds.

FIG. 23C is a photograph showing a further enlarged view of a portion of the flow pipe of FIGS. 21 and 23B with the internal helical flow tube for the flowable slurry of seeds.

FIG. 23D is a photograph showing a still more enlarged view of a portion of the flow pipe of FIGS. 21, 23B and 23C with an end cap supporting the internal helical flow tube for the flowable slurry of seeds.

FIG. 23E is a photograph showing a yet further enlarged view of a portion of the flow pipe of FIGS. 21, 23B, 23C and 23D with a portion of an end cap and the internal helical flow tube for the flowable slurry of seeds.

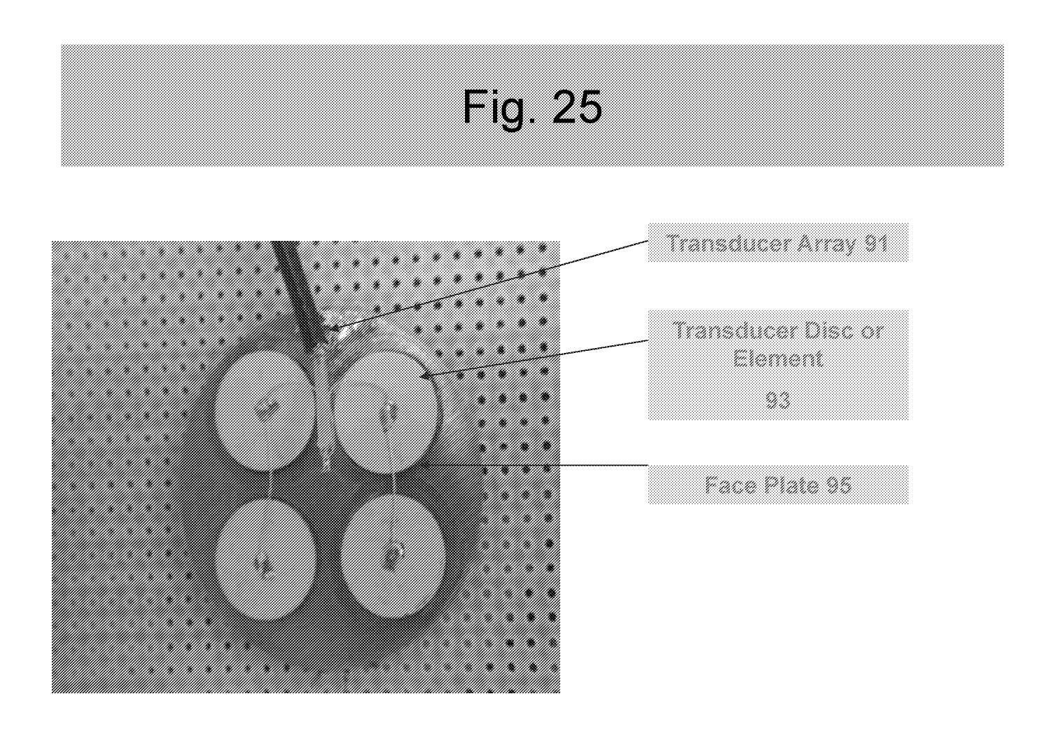

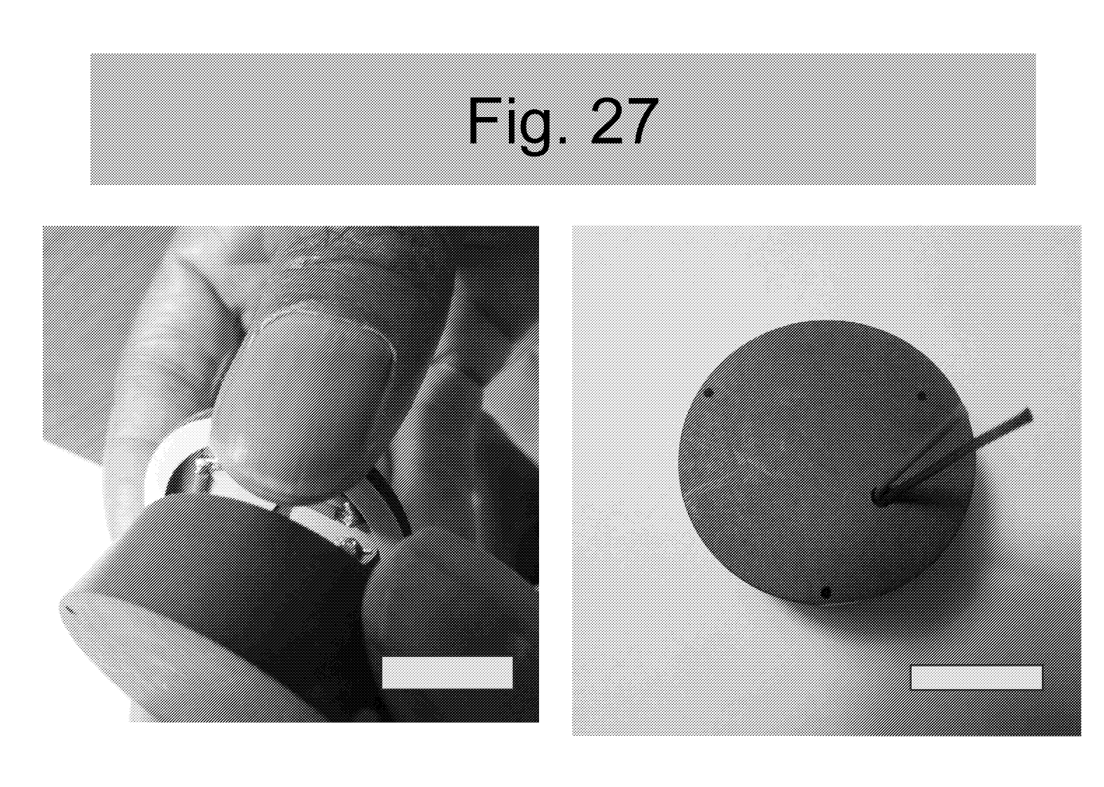

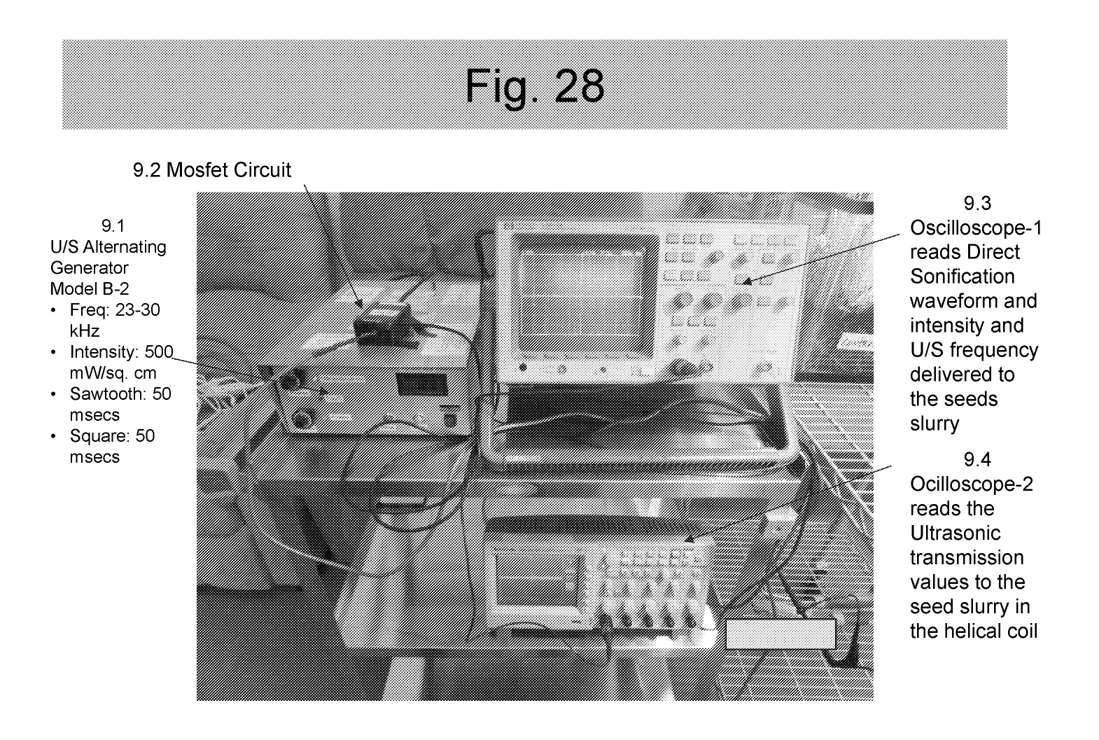

FIG. 24 is an illustration and two photographs of an embodiment of a unique ultrasonic transducer assembly and design capable of producing or generating an alternating ultrasonic waveform transmission, according to this invention. A transducer disc 93 is affixed via a conductive adhesive 94, preferably a conductive epoxy, onto a stainless steel face plate 95. A wire connection 92 connects the transducer discs through an enclosure sometimes called a block, with a reflective cover 90, to the ultrasonic driver system. The reflective cover 90) is sealed onto the face plate 95 by a foam rubber ring (not shown in FIG. 24; see FIGS. 26 and 27). Once sealed, the transducer assembly 91 emanates alternating ultrasound one direction. The transducer disc 93 may be piezoelectric or magnetorestrictive crystals that will generate a mechanical ultrasonic signal in the frequency and mechanical waveform delivered to it electronically by the ultrasonic generator. This design of the transducer assembly produced an alternating ultrasonic signal of 50 milliseconds sawtooth waveform followed by 50 milliseconds square waveform, with little or no cavitation or intense thermal effects. The text information on FIG. 24 is hereby incorporated into this description.

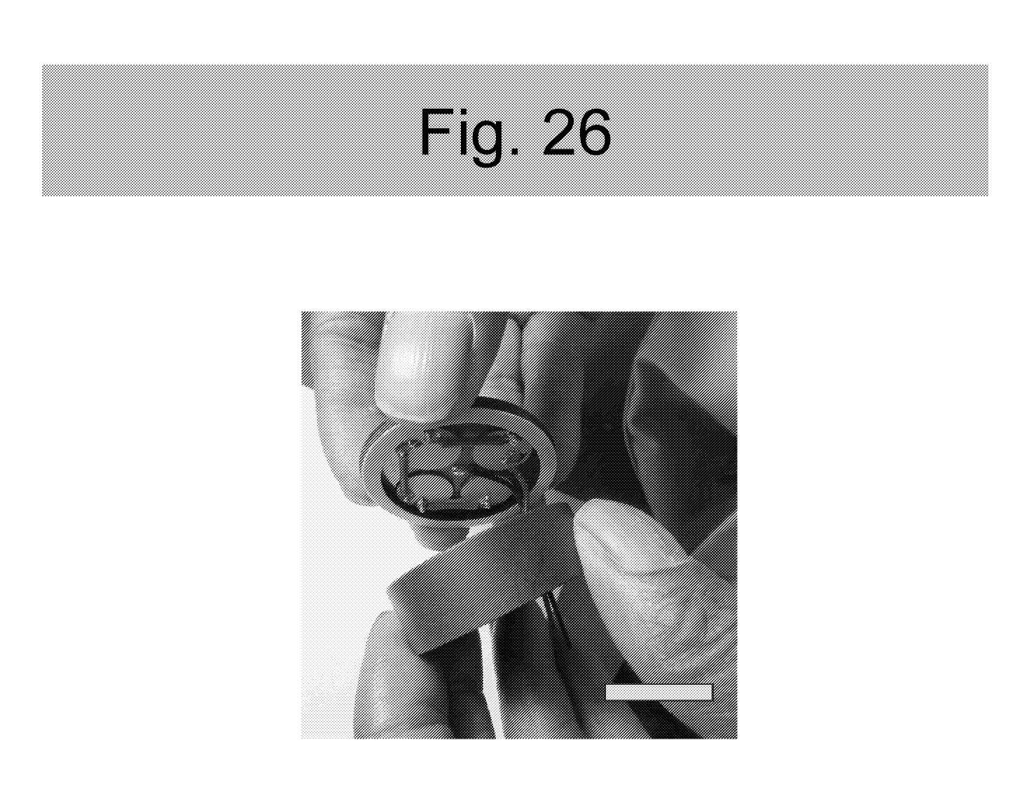

FIG. 25 is a photograph of an embodiment of an ultrasonic transducer coupler for use in this invention including an array having multiple transducer elements adhesively affixed to a face plate for the transducer assembly of FIGS. 24 and 25. With reference to both FIGS. 24 and 25, the transducer comprises the transducer assembly 93 with a back piece or block 90, which is made of a nylon or plastic. Wires 92 pass through the block 90 to a ground on the metal face plate 95, which is generally a stainless steel disc, and to the top of piezoelectric or magnetorestrictive transducer discs that are shown as constructed in array of 2 to 4 discs 93. In the illustration of FIG. 24, two such discs are shown, adhered through the use of conductive epoxy 94 to the face plate 95. FIG. 25 shows four such discs. A thin piece of foam rubber or a gasket is placed on the interior rim of the block 90 and the entire assemblage is sealed using an epoxy to a final or completed assembly as shown in the lower right photograph of FIG. 24 and in the right photograph of FIG. 27.

The transducer array shown in FIGS. 24 and 25 will develop an alternating ultrasonic transmission as shown in FIG. 7. The preferred combination waveform is a sawtooth waveform followed by a square waveform ultrasonic transmission. The time on any particular waveform can be varied to create either waveform effect. Alternating ultrasound signals are intended to minimize any cavitation effect upon the skin of the seed and avoid damage to seed shell but still speed uptake of moisture or other geminating regulating substances.

FIG. 26 is a photograph of views of an ultrasonic transducer assembly like the embodiments of FIGS. 24 and 25, in the process of being assembled to its block and reflective cover with wires running through the cover. This embodiment includes a foam ring adhesively adhering the transducer face plate to the rim of the block and reflective cover subassembly.

FIG. 27 includes two photographs showing the final assembly step and the finished assembly of the ultrasonic transducer shown in FIG. 26.

FIG. 28 is a photograph of the system or rigging for generating and controlling ultrasonic transmission in a preferred embodiment of the process and apparatus of the invention. The text information shown on FIG. 28 is hereby incorporated into this written description.

### EXPERIMENTS

A series of experiments was performed to demonstrate the effectiveness of the methods of the present invention, a continuous process for the ultrasonic treatment of seeds flowing in a helical path as previously described. Experiments were conducted using the laboratory apparatus shown in FIG. 18 and demonstrated in the photographs of FIGS. 20-22 and 23A-23E.

Two different crop seeds were examined, wheat and tomatoes. Each was sonicated at the same ultrasonic setting, using the transducer system shown in FIGS. 24 and 25, in an apparatus as shown in FIG. 20.

In FIG. 20, an ultrasonic generator known as Model B-2, and developed by Transdermal Specialties, Inc. of Broomall, Pa., USA, is used to generate the alternating ultrasonic transmission as shown in FIG. 7 and transmitted through the jacket of the apparatus shown in FIG. 18.

The ultrasonic settings for each experiment were:

### Ultrasound Frequency 23-30 kHz

### Intensity 0.5 W/sq. cm

Waveform Dynamic 50 msecs Sawtooth/50 msecs Square wave

### P-P Voltage 0.2-0.5 mV

### Procedure:

1. 4.115 lbs. of the target seed were added to 4.5 gallons of tap water at ambient temperature in a feed tank and stirred slowly to move the slurry as shown in FIG. 22.
2. A pump is used to draw the slurry through the helical coil which is sonicated by ultrasound. The length of the helical coil was 34.5 inches containing 15 helical spirals over the overall length of the tubing. The pump was set at a rate of 2 gallons per minute flow rate (2 gpm).
3. FIG. 22 shows that 35 transducer blocks were placed on all four sides of the jacket surrounding the helical tubing, which is ⅝ inch O.D. quartz glass tubing. The transducer blocks are aligned along the length of the jacket on all four sides and were designed to sonicate seeds traveling through the helical coil on each spiral and on all sides. No baffles were placed inside the spiral tubing.
4. The jacket was filled with tap water at ambient temperature.
5. The time to draw the seed tank per run was approximately 2.25 minutes.
6. One draw sonicates the seeds for one pass at approximately 1 minute of overall ultrasonic exposure. On a re-cycle mode, returning the seeds after each pass to the feed tank enabled multiple cycles of ultrasonic treatment.
7. All seed stock were treated for 1, 5, 10, 15 and 20 minute ultrasonic exposures in corresponding numbers (1, 5, 10, 15 and 20) of recycle runs.
8. After each run the seed slurry was sifted to draw away the water and the wet seeds were placed into a Hobart Planetary Mixer that had been fitted with a heat jacket. Under heat (150° F.) the seeds were stirred and the moisture driven off until the seeds had less than 5% by weight remaining moisture.
9. The filtered and dried seeds were then planted in a series of test aquariums filled with soil and the time for each planting resulting in germination was examined.

### Planting Test Configuration

1. 5 grams of control seeds were placed in a separate test aquarium in rows 2 inches apart from one another and stretching down the length of the test aquarium (12 inches). The seeds were planted in the soil, which had a depth of 8 inches. The control seeds were placed 1.5 inches into the soil.
2. The control seeds were then covered with the soil.
3. The control aquarium is placed under one Plant Growth lamp Model no. BR-30, 75 Watts, supplied by Phillips Co. The Lamps were 15 inches away from the soil generating a surface temperature of about 80° F.
4. The control aquarium was placed on a test rack under the Plant Growth lamps and connected to a timer which activated the lamps at 8:00 AM and deactivated the lamps at 6:00 PM.
5. The soil was irrigated with ¼ cup of tap water, at ambient temperature each morning at precisely 9:00 AM

### Growth of Ultrasonic Treated Seeds—Test Configuration

1. 5 grams of target seeds were placed in a separate test aquarium in rows 2″ inches apart from one another and stretching down the length of the test aquarium (12 inches). The target seeds were planted in the soil, which had a depth of 8 inches. The target seeds were placed 1.5 inches into the soil.
2. The target seeds were covered with the soil.
6. The target aquarium was placed under one Plant Growth lamp Model no. BR-30, 75 Watts, supplied by Phillips Co. The Lamps were 15 inches away from the soil generating a surface temperature of about 80° F.
3. The Target aquarium was placed on a test rack shown under the Plant growth lamps and connected to a timer which activated the lamps at 8:00 AM and deactivated the lamps at 6:00 PM.
4. The soil was irrigated with ¼ cup of tap water, at ambient temperature, each morning at precisely 9:00 AM
5. The test experiment continued until the seed germinated.

### Operation

Both the control and test experiments were run until the seeds germinated above the soil. The planting had one control seed vs. ultrasonically treated seeds, treated within the apparatus of the invention using the helical coil as described above for 1, 5, 10, 15 and 20 minutes of exposure to ultrasound.

### Results:

Table 1 shows the test results of two seed varieties which have been treated according to the continuous ultrasonic system for seeds, wherein seeds were placed in a liquid medium, namely water, and treated with ultrasound for exposure times up to 20 minutes in the helical continuous system of the present invention.

Using the continuous ultrasonic helical apparatus, the germination of wheat and tomato seeds was reduced. Wheat was reduced from 10 days to 3 days after the seeds were subjected to 20 minutes of ultrasound exposure. Tomato was reduced from 10 days to 3 days at just 5 minutes ultrasound exposure.

### Observations:

An examination of the seeds after initial ultrasonic exposure showed that the characteristic micro-holes shown in FIG. 8 were observed for both wheat and tomato seeds treated with the laboratory system of FIG. 9 and the continuous helix system of FIG. 22.

While the above experiments were conducted using the apparatus described in FIG. 22, it is believed that a device as illustrated in FIGS. 9, 10, 11, 12, 13, and 14 would achieve the same sonification effect applied to seeds, either in a batch or continuous treatment process. The preferred embodiment is one using the alternating ultrasound treatment applied to a seed which has been processed under a continuous system, ideally the helical system of the present invention, for the purpose of speeding germination and potentially final harvest times.

Seed treatment by ultrasonic transmission using conventional sinusoidal waveforms may still be effective, so long as the seeds are not damaged, which occurs often at frequencies of greater than 400 milliseconds at planted seed sonification, but the use of an alternating ultrasonic waveform system of sawtooth waveform followed by square waveform, which minimizes cavitation, is preferable.

The experimentation listed above showed that ultrasound-induced water uptake represents a unique event dissociable from normal water uptake. The differences in uptake rates of sonicated seeds and the control seeds showed that the sonicated seeds exhibit a much faster rate of germination than the non-sonicated seeds.

These results demonstrate that ultrasound-stimulated seeds probably have faster rates of water uptake, and these results are achieved very rapidly compared to the rates of water uptake of just soaked seeds. Thus, the sonication process fundamentally enhances the rate of uptake of substances into the seeds, speeding both seed germination and the growth of mature plants and crops. This process may therefore be used to reduce the time-to-harvest for many crops by first ultrasonically treating the seeds.

Those of ordinary skill in the art will understand in view of this application that by demonstrating the basic technique of enhanced seed growth through the sonication of the seeds in a growth medium will enable faster plant harvests, especially in weather stressed environments.

Crops emerging from ultrasonically treated seeds in the manners described above tend to have full growth plants and far less time to harvest than untreated crops.

The following Table 2 shows the results of tests done showing plant growth based on wheat, carrots, corn and tomato seeds, where the seeds were subjected to ultrasonic transmission in batch experiments where slurries of the seeds in water were subjected to ultrasonic transmission of sawtooth waveforms and square waveforms alternating at intervals of 50 milliseconds for 20 minutes. The frequency was 20 KHz-23 KHz; the energy density was 0.5 watt/cm2, and the It is believed that the results of these batch sonification experiments would be representative of the same type of ultrasonic transmission using the continuous process of the present invention.

Clearly, the considerably shorter time for seed germination shown in Table 2 for carrot, corn and tomato seeds will likely result in a significantly reduced time to harvest. The tomato seeds were grown to complete maturity and harvesting of tomato fruit from the tomato plants resulting from the ultrasonically treated tomato seeds. The comparison of the actual time to harvest of the treated tomato seeds to the normal time to harvest for tomato seeds was calculated and used to extrapolate a prediction of the time to harvest for the other seeds tested, based on their respective actual time to germination when ultrasonically treated versus their normal time to germination.

Although the invention has been described with respect to various embodiments, it is also to be understood that the invention is not to be so limited, since changes and modifications can be made therein which are within the full intended scope of this invention as defined by the appended claims.

1. A process for continuously treating seeds with ultrasonic transmission, the process comprising:
mixing seeds with a flowable medium to create a flowable slurry of seeds;
continuously moving the flowable slurry of seeds for a length of a flow pipe through a helical path within the flow pipe; and
as the flowable slurry flows through the helical path within and for the length of the flow pipe, subjecting the seeds to ultrasonic transmission created by ultrasonic transducers arranged along the length of the flow pipe;
the seeds in the flowable slurry being subjected to the ultrasonic transmission having such waveforms and being transmitted in a manner so as not to damage the seeds and to produce ultrasonically-treated seeds that have regulated germination characteristics, such that plants resulting from the ultrasonically-treated seeds when the seeds are planted have affected growth characteristics.

2. The process of claim 1, wherein the regulated germination characteristics are enhanced germination characteristics.

3. The process of claim 2, wherein the enhanced germination characteristics are caused by the seeds being imparted with at least one germination-enhancing substance from the slurry as the seeds are subjected to the ultrasonic transmission while the flowable slurry travels in the helical path through the length of the flow pipe.

4. The process of claim 3, wherein the germination-enhancing substance is selected from the group consisting of water, a fertilizer, a nutrient, a beneficial microorganism, a pest inhibitor, a hormone that promotes germination, a cytokinin that aids in cell elongation, an inhibitor of abscisic acid that promotes release from a dormancy condition of the seeds, and any combination thereof.

5. The process of claim 1, wherein the affected growth characteristics are any one or more of resistance to damage caused by a lack of sufficient water or excess water, regulated germination during cold temperatures, regulated germination during hot temperatures, and any combination thereof.

6. The process of claim 5, wherein the affected growth characteristics are regulated by uptake into the ultrasonically-treated seeds as the flowable slurry travels in the helical path along the length of the flow pipe of a substance in the flowable slurry selected from the group consisting of a triazole that moderates the effects of the lack of sufficient water and high temperatures; a fungicide that inhibits growth of fungi on the ultrasonically-treated seeds or seedlings resulting from the ultrasonically-treated seeds in cool, wet soil; and a growth retardant to retard germination of the seeds or any plants resulting from the seeds.

7. The process of claim 1, wherein the flowable medium comprises air.

8. The process of claim 1, wherein the flowable medium comprises water.

9. The process of claim 1, wherein the seeds are present in the flowable medium at a concentration of about 1% by weight to about 30% by weight.

10. The process of claim 1, wherein the flowable medium comprises water and the seeds are present in the flowable medium at a concentration of about 30% by weight.

11. The process of claim 1, wherein the flowable slurry flows through the length of the flow pipe at a rate of about 0.2 inch (0.51 cm) per second to about 1 inch (2.54 cm) per second.

12. The process of claim 1, wherein the ultrasonic transmission is at a frequency of about 15 kHz and about 175 kHz.

13. The process of claim 12, wherein the ultrasonic transmission is at a frequency of about 23 kHz and about 30 kHz.

14. The process of claim 1, wherein the ultrasonic transmission is at an energy density of about 0.125 watt/cm² to about 10 watts/cm².

15. The process of claim 1, wherein the ultrasonic transmission is at an energy density of about 0.5 watt/cm².

16. The process of claim 1, wherein the ultrasonic transmission is applied continuously.

17. The process of claim 1, wherein the ultrasonic transmission is applied in a pulsed manner.

18. The process of claim 1, wherein the ultrasonic transmission has one or more waveforms selected from the group consisting of sinusoidal, triangular, sawtooth and square.

19. The process of claim 1, wherein the ultrasonic transmission creates cavitation in the slurry, but does not damage the seeds.

20. The process of claim 1, wherein the ultrasonic transmission has one or more waveforms selected from the group consisting of sinusoidal, triangular, sawtooth and square and does not create cavitation in the slurry.

21. The process of claim 20, wherein the ultrasonic transmission has one or more alternating waveforms selected from the group consisting of sinusoidal, triangular, sawtooth and square and does not create cavitation in the slurry.

22. The process of claim 21, wherein the ultrasonic transmission has a sawtooth waveform alternating with a square waveform and does not create cavitation in the slurry.

23. The process of claim 22, wherein the sawtooth waveform and the square waveform alternate at intervals, and wherein each interval for each waveform is about 10 milliseconds to less than 400 milliseconds.

24. The process of claim 23, wherein the sawtooth waveform and the square waveform alternate at intervals of about 50 milliseconds each.

25. The process of claim 1, wherein the seeds are present in the flowable medium at a concentration of about 1% by weight to about 30% by weight, the flowable slurry flows through the length of the flow pipe at a rate of about 0.2 inch (0.51 cm) per second to about 1 inch (2.54 cm) per second, and the ultrasonic transmission is at a frequency of about 10 KHz to about 175 KHz and at an energy density of about 0.125 watt/cm² to about 10 watts/cm².

26. The process of claim 25, wherein the flowable medium comprises water, the seeds are present in the flowable medium at a concentration of about 5% by weight to about 30% by weight, the flowable slurry flows through the length of the flow pipe at a rate of about 0.3 inch (0.76 cm) per second to about 1 inch (2.54 cm) per second, and the ultrasonic transmission is at a frequency of about 15 KHz to about 100 KHz and at an energy density of about 0.225 watt/cm² to about 10 watts/cm².

27. The process of claim 26, wherein the flowable medium comprises water, the seeds are present in the flowable medium at a concentration of about 30% by weight, the flowable slurry flows through the length of the flow pipe at a rate of about 0.33 inch (0.84 cm) per second, and the ultrasonic transmission is at a frequency of about 20 KHz to about 23 KHz and at an energy density of about 0.5 watt/cm², with the ultrasonic transmission being in the form of alternating sawtooth waveforms and square waveforms, the sawtooth waveform and the square waveform alternating at intervals of about 50 milliseconds each.

28. The process of claim 27, wherein the flowable medium is a liquid medium, the process further comprising at least one of filtering and drying the treated seeds.

29. The process of claim 1, wherein the flowable medium is a liquid medium, the process further comprising drying the treated seeds.

30. Apparatus for treating seeds continuously with ultrasonic transmission, the seeds being mixed with a flowable first medium that creates a flowable slurry of seeds, the flowable slurry continuously moving for a length of a flow pipe through a helical path within the flow pipe, the apparatus comprising:
a flow pipe having an internal structure that forms a helical path for the length of the flow pipe for the flowable slurry that flows from an inlet to an outlet of the flow pipe; and
a plurality of ultrasonic transducers with a power supply for generating the ultrasonic transmission by the transducers, the transducers arranged along the length of the flow pipe and of sufficient number and placement to provide ultrasonic transmission to the flowable slurry of seeds as they travel through the helical path;
the ultrasonic transmission being applied by the ultrasonic transducers in a manner so as not to damage the seeds and to produce ultrasonically-treated seeds that have regulated germination characteristics, such that plants resulting from the ultrasonically-treated seeds when the seeds are planted have affected growth characteristics.

31. The apparatus of claim 30, wherein the helical path is created by internal baffles in the flow pipe arranged to direct the flowable slurry in the helical path.

32. The apparatus of claim 30, wherein the helical path is created by a helical tube within the flow pipe through which the flowable slurry flows through the helical tube for the length of the flow pipe.

33. The apparatus of claim 30, further comprising a pump to pump the flowable slurry through helical tube.

34. The apparatus of claim 30, wherein the helical path is created by a helical tube within the flow pipe through which the slurry flows through the helical tube for the length of the flow pipe;
the apparatus further comprising:
a pump to pump the flowable slurry through helical tube; and
the flow pipe is sealable to contain a liquid second medium within the flow pipe and surrounding the helical tube, such that the ultrasonic transmission is transmitted to the seeds in the helical tube through the liquid second medium.

35. The apparatus of claim 34, wherein the ultrasonic transducers are placed on the exterior of the flow tube, the flow tube having walls though which the ultrasonic transmission is capable of being transmitted.

36. The apparatus of claim 30, wherein the ultrasonic transducers are placed on the exterior of the flow tube, the flow tube having walls though which the ultrasonic transmission is capable of being transmitted.

37. The apparatus of claim 30, wherein the flowable first medium that creates the slurry for the flowable slurry of seeds is a liquid medium; and
wherein the apparatus further comprises:
a dryer to dry the ultrasonically-treated seeds; and
a conveyor to convey the ultrasonically-treated seeds to the dryer.

38. The apparatus of claim 37, wherein the conveyor is a pump capable of pumping to the dryer the flowable slurry of ultrasonically-treated seeds.

39. The apparatus of claim 38, wherein the conveyor is a moveable conveyor belt upon which the ultrasonically-treated seeds are deposited and conveyed to the dryer.

40. The apparatus of claim 37, wherein the flowable first medium that creates the slurry for the flowable slurry of seeds is a liquid medium; and
wherein the apparatus further comprises a filter to filter the ultrasonically-treated seeds from the liquid first medium containing the seeds that creates the flowable slurry.

41. The apparatus of claim 30, wherein each ultrasonic transducer is capable of generating from electrical input signals matching output alternating ultrasonic waveforms as the ultrasonic transmission, the transducer comprising:
one or more piezoelectric or magnetorestrictive discs, each disc being affixed onto a stainless steel face plate by an electrically conductive adhesive, the face plate being electrically connected to an ultrasonic generator that generates the electrical input signals and the matching output alternating ultrasonic waveforms as the ultrasonic transmission;
a plastic or metal block enclosure with a reflective cover containing the discs and overlying the stainless steel face plate; and
a foam rubber ring which connects the stainless steel face plate to the enclosure to enable the face plate to vibrate harmonically with respect to the ultrasonic transmissions from the transducer discs;
the reflective cover containing the discs and overlying the face plate reflecting the ultrasonic transmissions from the face plate back toward the face plate to concentrate the intensity and direction of the ultrasonic transmission.
